(19) United States
(12) Patent Application Publication
(10) Pub. No.: US 2011/0236627 A1
(43) Pub. Date: Sep. 29, 2011

(54) HONEYCOMB STRUCTURE AND METHOD FOR MANUFACTURING A HONEYCOMB STRUCTURE

(75) Inventor: Masanori KANAI, Ibi-gun (JP)

(73) Assignee: IBIDEN CO.,LTD., Ogaki-shi (JP)

(21) Appl. No.: 13/074,024

(22) Filed: Mar. 29, 2011

(30) Foreign Application Priority Data
Mar. 29, 2010 (JP) PCT/JP2010/055614

(51) Int. Cl. B32B 3/12; B32B 37/02; B32B 37/12; B32B 37/14; B32B 38/04

(52) U.S. Cl. 428/116; 156/60; 156/305; 156/250; 156/89.11

(57) ABSTRACT

A honeycomb structure includes honeycomb fired bodies, adhesive layers, and edge members. Each of the honeycomb fired bodies has a first end face, a second end face, and side faces. The adhesive layers are disposed on the side faces to bond the honeycomb fired bodies to each other. Each of the side faces has a first side that is one side of one of the first end face and the second end face. The edge members are disposed on the side faces and including an inorganic material. Each of the edge members has a substantially quadrangular pillar shape with a second side that has substantially a same width as the first side and that is disposed such that the second side is in a vicinity of one of the first end face and the second end face.

### CROSS-REFERENCE TO RELATED APPLICATIONS

The present application claims priority under 35 U.S.C. §119 to International Application No. PCT/JP2010/055614, filed Mar. 29, 2010, the contents of which are incorporated herein by reference in their entirety.

### BACKGROUND OF THE INVENTION

1. Field of the Invention

The present invention relates to a honeycomb structure and a method for manufacturing the honeycomb structure.

2. Discussion of the Background

Internal combustion engines of vehicles such as buses and trucks, construction machines, and the like discharge exhaust gas containing particulate matter (hereinafter, also referred to as PM) such as soot and other harmful matter, and harmfulness of this matter to the environment and human body has been a problem. Under such situation, there have been proposed various honeycomb structures including porous ceramics as honeycomb filters that capture PM in exhaust gas to purify the exhaust gas, or as catalyst-supporting carriers that allow exhaust gas to pass therethrough to convert harmful matter in the exhaust gas.

There has been proposed a honeycomb structure in which honeycomb fired bodies are bonded by interposing adhesive layers.

In the process of manufacturing the honeycomb structure of this kind, spacers (gap-maintaining members) disclosed in JP-A 2002-102627, WO 2003/031371 A1, JP-A2004-283699, or WO 2008/155856 A1 are used for maintaining the adhesive layers at a constant thickness upon the honeycomb fired bodies to manufacture a ceramic block.

JP-A 2002-102627 discloses a method in which an adhesive paste layer is formed on the side face of a honeycomb fired body; a cardboard spacer is disposed on the adhesive paste layer; another honeycomb fired body is disposed on the adhesive paste layer and the spacer such that the two honeycomb fired bodies sandwich the spacer to maintain the adhesive paste layer at a constant thickness; and the honeycomb fired bodies are bonded to each other.

WO 2003/031371 A1 discloses a method in which the spacer is made from an inorganic material having substantially the same composition as an adhesive. JP-A2004-283699 discloses a honeycomb structure having a spacer that is made from a porous ceramic, has a Young's modulus of 0.1 to 1.5 GPa, and has a porosity of 35 to 90%. WO 2008/155856 A1 discloses a honeycomb structure having a spacer that is made from a nonflammable material and has a Young's modulus of 0.001 to 0.07 GPa.

The contents of JP-A2002-102627, WO 2003/031371 A1, JP-A 2004-283699, and WO 2008/155856 A1 are incorporated herein by reference in their entirety.

### SUMMARY OF THE INVENTION

According to one aspect of the present invention, a honeycomb structure includes honeycomb fired bodies, adhesive layers, and edge members. The honeycomb fired bodies each have cell walls extending along a longitudinal direction of the honeycomb fired bodies to define cells. Each of the honeycomb fired bodies has a first end face, a second end face opposite to the first end face in the longitudinal direction, and side faces provided between the first end face and the second end face. The adhesive layers are disposed on the side faces to bond the honeycomb fired bodies to each other. Each of the side faces has a first side that is one side of one of the first end face and the second end face. The edge members are disposed on the side faces and include an inorganic material. Each of the edge members has a substantially quadrangular pillar shape with a second side that has substantially a same width as the first side and that is disposed such that the second side is in a vicinity of one of the first end face and the second end face.

According to another aspect of the present invention, a method for manufacturing a honeycomb structure includes providing honeycomb fired bodies each having cell walls extending along a longitudinal direction of the honeycomb fired bodies to define cells. Each of the honeycomb fired bodies has a first end face, a second end face opposite to the first end face in the longitudinal direction, and side faces provided between the first end face and the second end face. Each of the side faces has the first side that is one side of one of the first end face and the second end face. Edge members are disposed on the side faces. The edge members include an inorganic material. Each of the edge members has a substantially quadrangular pillar shape with a second side that has substantially a same width as the first side and that is disposed such that the second side is in a vicinity of one of the first end face and the second end face. The honeycomb fired bodies are bonded with the edge members by interposing adhesive paste layers between the honeycomb fired bodies to manufacture a honeycomb aggregate. The adhesive paste layers are solidified to provide adhesive layers.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic perspective view showing one example of the honeycomb structure according to one embodiment of the present invention;

FIG. 2A is a schematic perspective view showing one example of the honeycomb fired body that constitutes the honeycomb structure according to one embodiment of the present invention shown in FIG. 1; and FIG. 2B is an A-A line cross-sectional view of the honeycomb fired body shown in FIG. 2A;

FIG. 3A is a schematic perspective view showing the state that the adhesive layer and the edge member are disposed on the side face of the honeycomb fired body shown in FIG. 2A; and FIG. 3B is an enlarged schematic perspective view of the vicinity of the edge member shown in FIG. 3A;

FIGS. 4A, 4B, 4C and 4D are schematic explanatory views showing one example of the procedure of manufacturing the honeycomb structure according to the first embodiment of the present invention;

FIGS. 5A, 5B, 5C, and 5D are schematic explanatory views showing another example of the procedure of manufacturing the honeycomb structure according to the first embodiment of the present invention;

FIG. 6 is a schematic perspective view showing one example of the honeycomb structure according to the fifth embodiment of the present invention;

FIG. 7A is a schematic perspective view showing one example of the honeycomb fired body that constitutes the honeycomb structure according to the fifth embodiment of the present invention shown in FIG. 6; and FIG. 7B is an A-A line cross-sectional view showing the honeycomb fired body shown in FIG. 7A;

FIG. 8 is a schematic cross-sectional view showing the state of forming an edge member and an adhesive paste layer on the honeycomb fired body with a V-profile stage according to the fifth embodiment of the present invention;

FIG. 9 is a schematic perspective view showing one example of the honeycomb structure according to the sixth embodiment of the present invention;

FIG. 10 is a schematic perspective view showing one example of the honeycomb fired body disposed on the peripheral portion of the honeycomb structure according to the sixth embodiment of the present invention;

FIGS. 11A, 11B, 11C, 11D, 11E, 11F, 11G, and 11H are schematic explanatory views showing one example of the procedure of manufacturing the honeycomb structure according to the sixth embodiment of the present invention;

FIGS. 12A, 12B, 12C, and 12D are schematic explanatory views showing one example of the procedure of manufacturing the honeycomb structure according to the sixth embodiment of the present invention; and

FIG. 13 is an enlarged side view showing the honeycomb jointed body shown in FIG. 12B.

### DESCRIPTION OF THE EMBODIMENTS

The embodiments will now be described with reference to the accompanying drawings, wherein like reference numerals designate corresponding or identical elements throughout the various drawings.

In the case that a honeycomb structure is used as an exhaust gas purifying filter, the honeycomb structure after used for a predetermined period of time is subjected to a regenerating process in which captured PM is burnt to be removed from the honeycomb structure. The regenerated honeycomb structure is again used as an exhaust gas purifying filter. In the regenerating process, the honeycomb structure is exposed to high temperature due to burning of PM.

The conventional spacer disclosed in JP-A 2002-102627 disadvantageously disappears to form a void in the adhesive layer when the honeycomb structure is exposed to high temperature in processes such as a regenerating process. On the other hand, the conventional spacers disclosed in WO 2003/031371 A1, JP-A 2004-283699, or WO 2008/155856 A1 are made from inorganic materials, and thus the spacers do not disappear and do not form voids in the adhesive layers.

Further, the conventional spacers disclosed in JP-A 2002-102627, WO 2003/031371 A1, JP-A2004-283699, or WO 2008/155856 A1 are used for maintaining the adhesive layers at a constant thickness. Thus, each spacer is disposed so as to be embedded in the adhesive layer with a predetermined size.

In the usual method for manufacturing a honeycomb structure, an adhesive paste is applied to a side face of a honeycomb fired body in an amount such that the adhesive layer has substantially the same thickness as a spacer after the honeycomb fired body and another honeycomb fired body are bonded to each other by interposing the adhesive layer. However, it is difficult to adjust the amount of the adhesive paste so that the adhesive layer has strictly the same thickness as the spacer. A smaller amount of the adhesive paste tends to cause space in the adhesive layer; thus, a slightly large amount of the adhesive paste is applied to the side face of the honeycomb fired body.

As a result, the adhesive paste is pushed out toward an end face side when the honeycomb fired bodies are bonded to each other by interposing the adhesive paste layer and the adhesive paste tends to stick to the end face of the honeycomb fired body in these cases. If the adhesive paste sticks to the end face of the honeycomb fired body, a cell that should not be sealed of the honeycomb fired body is disadvantageously sealed.

In order to prevent sticking of the adhesive paste to the end face of the honeycomb fired body, a film is attached to the end face of the honeycomb fired body and is removed therefrom after the honeycomb fired bodies are bonded to each other. However, this technique makes the process complicated and increases the production cost.

The honeycomb structure and the method for manufacturing a honeycomb structure according to embodiments of the present invention may provide: a honeycomb structure that is less likely to suffer problems such as sealing failure at an end face of the honeycomb fired body due to the adhesive paste pushed out toward the end face side of the honeycomb fired body, and in which a disposed member (edge member) is less likely to disappear under high temperature conditions such as the regenerating process; and easily and inexpensively manufacture a honeycomb structure in which the adhesive paste is less likely to be pushed out toward an end face side of the honeycomb fired body and thus which is less likely to suffer problems such as sealing failure at the end face of the honeycomb fired body.

A honeycomb structure according to an embodiment of the present invention includes: honeycomb fired bodies each having a large number of cells longitudinally disposed in parallel with each other with a cell wall interposed therebetween, and each having side faces and end faces; adhesive layers disposed on the side faces and each adhesive layer bonding the honeycomb fired bodies to each other; and edge members disposed on the side faces, each side face that contacts the adhesive layer having a side A (a first side) that is shared with one of the end faces, each edge member including an inorganic material, having a substantially quadrangular pillar shape with a side X (a second side) that has substantially the same width as the side A, and being disposed such that the side X is brought close to the end face.

In the honeycomb structure according to the embodiment of the present invention, the side X of the edge member has substantially the same width as the side face of the honeycomb fired body, and is brought close to the end face of the honeycomb fired body. Thus, the adhesive paste tends to be prevented from leaking across the edge member of the honeycomb fired body, and the honeycomb structure tends not to suffer sealing failure at the end face of the honeycomb fired body due to sticking of the adhesive paste to the end face of the honeycomb fired body, in other words, portions (cells) that should not be sealed of the honeycomb fired body tend not to be sealed and the adhesive paste tends not to stick to cells that should not be sealed. As a result, the honeycomb structure of the embodiment of the present invention may sufficiently serve as a filter that captures PM in exhaust gas to purify the exhaust gas. As mentioned above, the edge member of the embodiment of the present invention may prevent leakage of the adhesive paste; thus, it is also referred to as a leakage inhibitor.

In addition, since the edge member of the honeycomb structure according to the embodiment of the present invention includes an inorganic material, the edge member is less likely to disappear during processes such as the regenerating process and defects such as space tend not to occur in the portion where the edge member or the adhesive layer is disposed. Thus, the honeycomb structure tends to prevent defects such as crackings starting from the space formed in the portion where the edge member or the adhesive layer used to be disposed due to expansion and shrinkage of the honeycomb fired body, the edge member, and/or the adhesive layer when they are exposed to high temperature during processes such as the regenerating process.

The following will describe the edge member.

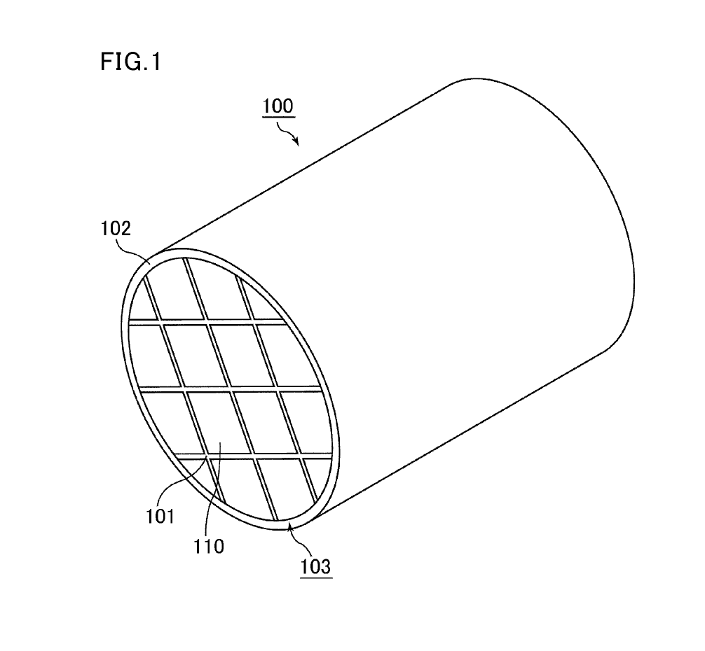

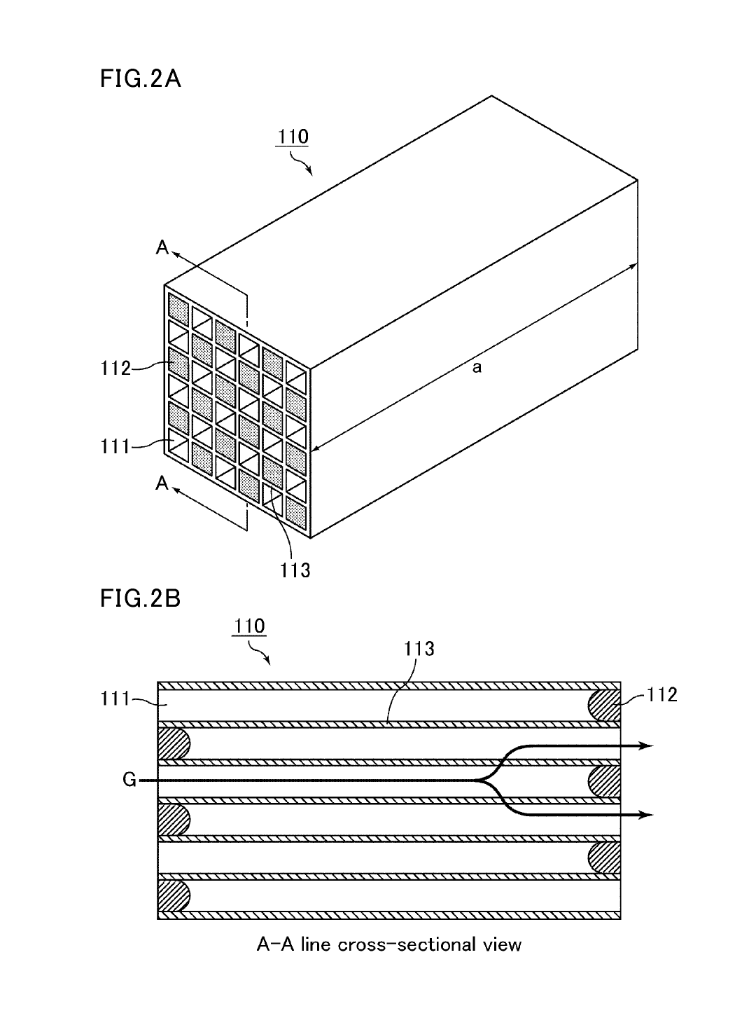

FIG. 1 is a schematic perspective view showing one example of the honeycomb structure according to one embodiment of the present invention. FIG. 2A is a schematic perspective view showing one example of the honeycomb fired body that constitutes the honeycomb structure shown in FIG. 1. FIG. 2B is an A-A line cross-sectional view of the honeycomb fired body shown in FIG. 2A.

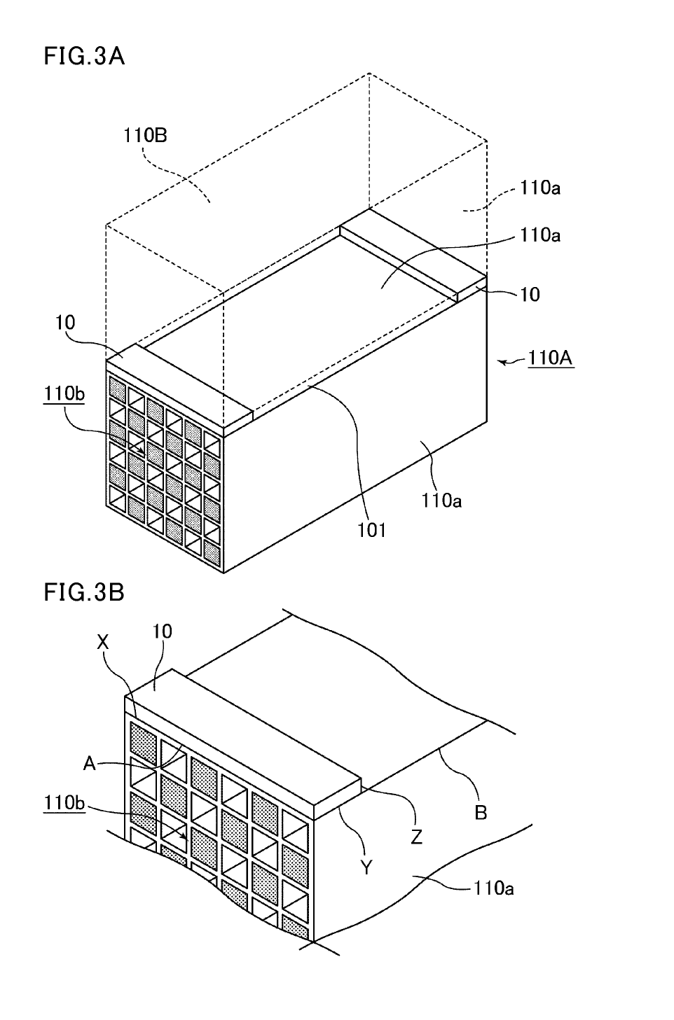

FIG. 3A is a schematic perspective view showing a state in which an adhesive layer and edge members are disposed on the side face of the honeycomb fired body shown in FIG. 2A. FIG. 3B is an enlarged schematic perspective view showing the vicinity of one of the edge members shown in FIG. 3A, wherein only the lower honeycomb fired body is illustrated.

The honeycomb structure 100 of the embodiment of the present invention shown in FIG. 1 includes honeycomb fired bodies 110 each having the structure shown in FIGS. 2A and 2B. These honeycomb fired bodies 110 are bonded to each other by interposing adhesive layers 101 to form a ceramic block 103. This ceramic block 103 has a coating layer 102 on its periphery.

The honeycomb fired body 110 shown in FIGS. 2A and 2B includes a large number of cells 111 longitudinally (the direction indicated by a in FIG. 2A) disposed in parallel with each other with a cell wall 113 interposed therebetween, and either one end of each cell 111 is sealed with a plug 112. Thus, exhaust gas G flowing into one cell 111 that has an opening on one end face of the honeycomb fired body 110 always passes through the cell wall 113 separating the cell 111 from an adjacent cell, and then flows out from other cells 111 that has an opening on the other end face of the honeycomb fired body 110.

Therefore, the cell wall 113 serves as a filter for capturing PM and the like matter.

In the honeycomb structure 100 of the embodiment of the present invention, the adhesive layer 101 is formed between a side face 110a of a substantially quadrangular pillar-shaped honeycomb fired body 110A illustrated with a solid line and a side face 110a of a substantially quadrangular pillar-shaped honeycomb fired body 110B illustrated with a dot line in FIG. 3A. This adhesive layer bonds the two honeycomb fired bodies 110A and 110B to each other.

As shown in FIGS. 3A and 3B, the side face 110a of the honeycomb fired body 110 of the embodiment of the present invention has a substantially rectangular shape that has a side A shared with an end face 110b of the honeycomb fired body 110 and a side B perpendicular to the side A. Two edge members 10 are disposed on this side face 110a of the honeycomb fired body 110. These two edge members 10 each have a substantially quadrangular pillar shape, having a side X that has substantially the same width as the side A of the side face 110a, a side Y (a third side) in the width direction, and a side Z (a fourth side) in the thickness direction. The edge members each are disposed such that the XY plane contacts the side face 110a and the side X is brought close to the end face 110b of the honeycomb fired body 110.

The term “a substantially quadrangular pillar shape” herein means that shapes close to a quadrangular pillar shape are included in its scope. For example, a substantially quadrangular pillar shape includes a shape in which a corner portion of a quadrangle formed by cutting the edge member 10 in the plane parallel to the side face 110a with the edge member 10 bonded thereto is chamfered with a curved line or a straight line.

The side X of the edge member 10 is preferably located at a distance of about 3 mm or less from the side A (end face 110b) shared between the side face 110a and the end face, more preferably at a distance of about 1 mm or less from the end face (end face 110b), and is further preferably shared with the end face (end face 110b).

The side X is preferably separated from the side A (end face 110b) by about 3 mm or less from the viewpoint of sufficient strength of the honeycomb structure. The reason why the side X is preferably separated from the end face (end face 110b) by about 1 mm or less is that a distance of about 1 mm or less from the end face (end face 110b) is less likely to cause deterioration in performance of the honeycomb structure, such as pressure loss. In the case that the honeycomb structure is used as a catalyst-supporting carrier, the side X is preferably shared with the end face of the honeycomb fired body.

The edge member 10 may be disposed for the purpose of maintaining the adhesive layer 101 at a substantially constant thickness. In this case, the adhesive layer 101 preferably has a substantially constant thickness that is substantially the same as the edge member 10. In the case that the edge member 10 maintains the adhesive layer at a predetermined thickness as mentioned here, the edge member 10 also serves as a spacer (gap-maintaining member).

The edge member 10 of the embodiment of the present invention may be a solidified adhesive paste. In other words, it may be one formed by applying a substance having substantially the same composition as the adhesive paste to the vicinity of the end face on the side face 110a of the honeycomb fired body 110 as shown in FIG. 3A and then solidifying the substance. The degree of solidification is not particularly limited, and may be such that the edge member 10 does not flow to stick to the end face of the honeycomb fired body 110 when the honeycomb fired bodies 110A and 110B are bonded to each other and that the edge member 10 prevents the adhesive paste to be applied later from leaking toward the end face side of the honeycomb fired bodies.

Alternatively, the edge member 10 of the embodiment of the present invention may include a nonflammable material. In this case, the edge member may be one prepared by applying a substance that serves as an adhesive paste to the main face of a sheet material having a substantially quadrangular pillar shape as shown in FIG. 3A, and by attaching it to the vicinity of the end face on the side face 110a of the honeycomb fired body 110A by interposing the adhesive paste.

Alternatively, the edge member 10 of the embodiment of the present invention may include substantially the same material as the honeycomb fired body 110. In this case, the edge member may be one formed in the vicinity of the end face on the side face 110a of a honeycomb molded body so as to have a shape of the edge member and then fired so as to be integrated with the honeycomb fired body.

Alternatively, the edge member 10 of the embodiment of the present invention may be a paste having a higher viscosity than the aforementioned adhesive paste. In this case, the edge member may be a paste that does not flow to stick to the end face of the honeycomb molded body when the edge member 10 is formed in the vicinity of the end face on the side face of the honeycomb molded body, that sufficiently prevents leakage of the adhesive paste, and that may have a substantially quadrangular pillar shape as shown in FIG. 3A.

In the case that a highly viscous paste is used as the edge member 10, the highly viscous paste is dried and solidified to serve as a solidified edge member.

The edge member 10 of the embodiment of the present invention is disposed between the two honeycomb fired bodies 110A and 110B, and may be used in combination with a spacer (gap-maintaining member). In this case, the edge member 10 and the spacer (gap-maintaining member) are disposed on different positions, and are not disposed on the same position.

In the case that the edge member is not a highly viscous paste, the edge member paste and the adhesive paste are solidified at different timings. Thus, a border line is formed between the edge member and the adhesive layer. Specifically, the border line is observed in an SEM photograph of the cross section of the honeycomb fired body with the edge member and the adhesive layer formed thereon, although the edge member and the adhesive layer are bonded to each other. This cross section is formed by crosscutting the honeycomb fired body with the edge member and the adhesive layer formed thereon in the longitudinal direction.

In the honeycomb structure of the embodiment of the present invention, the edge members are preferably disposed on both edge portions of every side face with the adhesive layer formed thereon of the honeycomb fired bodies such that the side X is shared with the end face of the honeycomb fired body.

Since the edge members are disposed on both edge portions of every side face with the adhesive layer formed thereon such that the side X is shared with the end face of the honeycomb fired body in the honeycomb structure of the embodiment of the present invention, the honeycomb structure is less likely to suffer problems such as sealing failure at all the end faces of the honeycomb fired bodies, and all the cells that should be open are open. Thus, the honeycomb structure may sufficiently serve as a filter that captures PM in exhaust gas to purify the exhaust gas. Since the formed edge member contacts the end face of the honeycomb fired body, the whole end face of the honeycomb structure tends to be formed to have a flat surface.

As a result, the honeycomb structure is less likely to suffer deterioration of the performance such as pressure loss.

The edge member of the honeycomb structure according to the embodiment of the present invention preferably includes inorganic particles B (first inorganic particles) and inorganic fibers B (first inorganic fibers). Thus, the edge member has elasticity. In addition, the honeycomb structure tends to prevent defects such as crackings inside the edge member or the adhesive layer due to expansion and shrinkage of the honeycomb fired body, the edge member, and/or the adhesive layer when they are exposed to high temperature during processes such as the regenerating process; also, the honeycomb structure has excellent mechanical properties as a whole.

The edge member of the honeycomb structure according to the embodiment of the present invention preferably further includes solid matter of an inorganic binder. Thus, the edge member easily keeps its shape, is easily manufactured, and is easily disposed on the side face of the honeycomb fired body. In addition, the edge member of this kind tends to have excellent adhesiveness to the honeycomb fired body.

The edge member of the honeycomb structure according to the embodiment of the present invention preferably has substantially the same composition as the adhesive layer. Thus, the edge member has substantially the same mechanical properties as the adhesive layer. As a result, the honeycomb structure is less likely to suffer defects such as crackings inside the edge member or the adhesive layer even when thermal stress is generated in the edge member or the adhesive layer due to expansion and shrinkage of the honeycomb fired body, the edge member, and/or the adhesive layer when they are exposed to high temperature during processes such as the regenerating process.

The edge member of the honeycomb structure according to the embodiment of the present invention preferably further includes inorganic particles D (second inorganic particles) or a layered inorganic material.

The honeycomb fired body that is located at a peripheral portion of the honeycomb structure according to the embodiment of the present invention preferably has a peripheral wall on a peripheral portion of the honeycomb fired body.

Thus, use of this honeycomb fired body enables manufacturing of the honeycomb structure with a predetermined shape only by bonding the honeycomb fired bodies by interposing the adhesive paste and solidifying the adhesive paste, and without the process of cutting the peripheral portion of the ceramic block (honeycomb aggregate).

A method for manufacturing a honeycomb structure of an embodiment of the present invention provides a honeycomb structure that includes honeycomb fired bodies each having a large number of cells longitudinally disposed in parallel with each other with a cell wall interposed therebetween and each having side faces and end faces, adhesive layers disposed on the side faces and each adhesive layer bonding the honeycomb fired bodies, and edge members disposed on the side faces, the method including: disposing the edge members, each edge member has a substantially quadrangular pillar shape having a side X, on the side faces, each side face having a side A that is shared with one of the end faces of the honeycomb fired body and that has substantially the same width as the side X, such that the side X is brought close to the side A; manufacturing a honeycomb aggregate by bonding the honeycomb fired bodies with the edge members disposed thereon by interposing adhesive paste layers; and solidifying the adhesive paste layers to form the adhesive layers.

In the method for manufacturing a honeycomb structure of the embodiment of the present invention, the adhesive paste is not pushed out to the end face side of the honeycomb fired body across the edge member upon manufacturing a honeycomb aggregate, and thus the adhesive paste does not attach to the end face of the honeycomb fired body. As a result, sealing failure is less likely to occur that is caused by the adhesive paste sealing or attaching to cells that should be open of the honeycomb fired body.

In addition, since the edge member of the obtained honeycomb structure includes an inorganic material, it is less likely to disappear even when exposed to high temperature during processes such as the regenerating process. Thus, the honeycomb structure tends to prevent defects caused by disappearance of the edge member such as crackings starting from the space formed inside the edge member or the adhesive layer due to expansion and shrinkage of the honeycomb fired body, the edge member, and/or the adhesive layer when they are exposed to high temperature during processes such as the regenerating process.

In the method for manufacturing a honeycomb structure of the embodiment of the present invention, the manufacturing a honeycomb aggregate preferably includes: applying an adhesive paste to one of the side faces of a first one of the honeycomb fired bodies with the edge members disposed thereon; bonding one of the side faces of a second one of the honeycomb fired bodies to the adhesive paste applied to the one of the side faces of the first one of the honeycomb fired bodies; and repeating the applying and the bonding to manufacture a honeycomb aggregate.

In the method for manufacturing a honeycomb structure of the embodiment of the present invention, the honeycomb aggregate is manufactured by repeating the applying of an adhesive paste and the bonding. During these steps, the adhesive paste is less likely to be pushed out to the end face side of the honeycomb fired body across the edge member. Thus, sealing failure of the honeycomb fired body is less likely to occur that is caused by the adhesive paste sealing or attaching to cells that should be open of the honeycomb fired body.

In the method for manufacturing a honeycomb structure of the embodiment of the present invention, the manufacturing a honeycomb aggregate preferably includes: jointing the honeycomb fired bodies with the edge members disposed thereon by interposing the edge members to manufacture a honeycomb jointed body; housing the honeycomb jointed body in a jointed body-housing container that is a part of an adhesive-filling apparatus; and filling an adhesive paste into gaps formed between the honeycomb fired bodies of the honeycomb jointed body to form layers to be adhesive layers.

In the method for manufacturing a honeycomb structure of the embodiment of the present invention, the edge member is used for bonding and jointing the honeycomb fired bodies to each other to form a shape of the honeycomb structure while separating them at a substantially constant distance, and thereafter the adhesive paste is charged at one time into the gaps formed between the honeycomb fired bodies to form the adhesive layers. Thus, sealing failure is less likely to occur at the end face of the honeycomb fired body as mentioned above, and the honeycomb structure is likely to be efficiently manufactured.

In the method for manufacturing a honeycomb structure of the embodiment of the present invention, the manufacturing a honeycomb aggregate preferably includes: jointing the honeycomb fired bodies with the edge members disposed thereon by interposing the edge members to manufacture a honeycomb jointed body; preparing a jointed body-housing container that is a part of an adhesive-filling apparatus and that is designed to have a size such that the honeycomb jointed body and the jointed body-housing container form a gap having a predetermined distance therebetween; housing the honeycomb jointed body in the jointed body-housing container to form the gap having a predetermined distance between the honeycomb jointed body and the jointed body-housing container; and filling an adhesive paste into gaps between the honeycomb fired bodies of the honeycomb jointed body and into the gap between the honeycomb jointed body and the jointed body-housing container to form layers to be adhesive layers and a layer to be a coating layer.

In the method for manufacturing a honeycomb structure of the embodiment of the present invention, the edge member is used for jointing (bonding) the honeycomb fired bodies to each other to form a shape of the honeycomb structure while separating them at a substantially constant distance, and thereafter the adhesive paste is charged at one time into the gaps formed between the honeycomb fired bodies to form the adhesive layers, and further the adhesive paste is applied to the periphery to form the coating layer. As a result, sealing failure is less likely to occur at the end face of the honeycomb fired body as mentioned above, and the honeycomb structure is likely to be more efficiently manufactured.

In addition, the adhesive paste to be a coating layer is also solidified when the adhesive paste is solidified. Thus, the coating layer may be simultaneously formed upon forming the adhesive layers, and the honeycomb structure is likely to be more efficiently manufactured.

In the method for manufacturing a honeycomb structure of the embodiment of the present invention, the edge members are preferably disposed on both edge portions of every side face with the adhesive layer formed thereon of the honeycomb fired bodies such that a side X is shared with the end face of the honeycomb fired body.

Thus, at every end face portion of the honeycomb fired bodies the adhesive paste tends not to stick to the end face of the honeycomb fired body, and cells that should be open of the honeycomb fired body are open and the adhesive paste tends not to be filled into or stick to the cells that should be open of the honeycomb fired body in the provided honeycomb structure. As a result, the honeycomb structure may sufficiently serve as a filter that captures PM in exhaust gas to purify the exhaust gas. In addition, since the formed edge member contacts the end face of the honeycomb fired body, the whole end face of the provided honeycomb structure is likely to have a flat surface.

Thus, the honeycomb structure is less likely to suffer deterioration of the performance such as pressure loss.

In the method for manufacturing a honeycomb structure of the embodiment of the present invention, the edge member is preferably bonded to the side face by interposing the adhesive paste. Thus, the edge member may be appropriately bonded to the side face of the honeycomb fired body and the bottom of the edge member and the side face of the honeycomb fired body are bonded to each other by interposing the adhesive paste. As a result, the edge member tends to be prevented from displacing from a predetermined position.

In the method for manufacturing a honeycomb structure of the embodiment of the present invention, the edge member is preferably a highly viscous paste. Since the edge member is a highly viscous paste, the edge member tends to be appropriately bonded to the side face of the honeycomb fired body, and the edge member tends to be easily disposed on the side face of the honeycomb fired body. In addition, even though the edge member is in a paste state, adhesive strength between the side face of the honeycomb fired body and the highly viscous edge member tends to prevent the adhesive paste from leaking toward the end face of the honeycomb fired body.

In the method for manufacturing a honeycomb structure of the embodiment of the present invention, the edge member preferably includes inorganic particles B and inorganic fibers B. Thus, the edge member has elasticity, and the honeycomb structure is less likely to suffer problems such as crackings in the edge member or the adhesive layer due to expansion and shrinkage of the honeycomb fired body, the edge member, and/or the adhesive layer when they are exposed to high temperature in processes such as the regenerating process. As a result, this method is likely to provide a honeycomb structure that is also excellent in mechanical properties as a whole.

In the method for manufacturing a honeycomb structure of the embodiment of the present invention, the edge member preferably further includes an inorganic binder. Thus, the edge member is likely to keep its shape easily, the edge member is more easily manufactured, and the edge member is easily disposed on the side face of the honeycomb fired body. Further, the edge member is likely to be allowed to have excellent adhesiveness to the honeycomb fired body.

In the method for manufacturing a honeycomb structure of the embodiment of the present invention, the edge member preferably has substantially the same composition as the adhesive layer. Thus, the edge member has substantially the same mechanical properties as the adhesive layer. As a result, the provided honeycomb structure is less likely to suffer defects such as crackings inside the edge member or the adhesive layer even when thermal stress is generated in the edge member or the adhesive layer due to expansion and shrinkage of the honeycomb fired body, the edge member, and/or the adhesive layer when they are exposed to high temperature during processes such as the regenerating process.

In the method for manufacturing a honeycomb structure of the embodiment of the present invention, the edge member preferably further includes inorganic particles D or a layered inorganic material.

In the method for manufacturing a honeycomb structure of the embodiment of the present invention, a honeycomb fired body that is located at a peripheral portion of the honeycomb structure preferably has a peripheral wall on a peripheral portion of the honeycomb fired body. In the case that the honeycomb fired body of this kind is used, the honeycomb structure having a predetermined shape may be manufactured only by bonding the honeycomb fired bodies by interposing an adhesive paste and solidifying the adhesive paste, and without the process of cutting the peripheral portion of the ceramic block (honeycomb aggregate).

The method for manufacturing a honeycomb structure of the embodiment of the present invention preferably further includes cutting the honeycomb aggregate to form a peripheral portion after the adhesive paste layer is solidified. This cutting enables manufacturing of a honeycomb structure with a predetermined shape.

The method for manufacturing a honeycomb structure of the embodiment of the present invention preferably further includes forming a coating layer on the periphery after the cutting. This formation of the coating layer enables manufacturing of a honeycomb structure that does not suffer problems such as gas leakage at the peripheral portion.

In the method for manufacturing a honeycomb structure of the embodiment of the present invention, the edge member is preferably a paste having a viscosity of from about 60 Pa·s to about 100 Pa·s. The edge member having a viscosity of this range is easily fixed on the side face of the honeycomb fired body. In addition, adhesive strength between the bottom of the edge member and the side face of the honeycomb fired body is likely to prevent displacement of the edge member. As a result, a honeycomb aggregate is easily manufactured.

In the method for manufacturing a honeycomb structure of the embodiment of the present invention, the edge member is preferably a solidified matter or a fired matter having a predetermined shape.

### First Embodiment

The following will describe the first embodiment that is one embodiment of the present invention referring to the drawings.

The present embodiment illustrates the casein which the honeycomb fired body that constitutes the honeycomb structure is a porous silicon carbide, and the edge member 10 is a solidified one having substantially the same composition as the adhesive paste.

In this case, the edge member preferably includes inorganic particles A (third inorganic particles), an inorganic binder, an organic binder, and at least one of inorganic fibers A (second inorganic fibers), whiskers, a scaly inorganic material, and a layered inorganic material.

Examples of the inorganic binder in the edge member include silica sol, alumina sol, and the like. Each of these may be used alone or two or more of these may be used in combination. The inorganic binder is preferably silica sol. The lower limit of the amount of the inorganic binder (as solids content) is preferably about 1% by weight, and more preferably about 5% by weight. The upper limit of the amount of the inorganic binder (as solids content) is preferably about 30% by weight, and more preferably about 15% by weight.

Examples of the organic binder in the edge member include polyvinyl alcohol, methyl cellulose, ethyl cellulose, carboxymethyl cellulose, and the like. Each of these may be used alone or two or more of these may be used in combination. The organic binder is preferably carboxymethyl cellulose. The lower limit of the amount of the organic binder is preferably about 0.1% by weight, and more preferably about 0.2% by weight. The upper limit of the amount of the organic binder is preferably about 5.0% by weight, and more preferably about 1.0% by weight.

Examples of the inorganic fibers A in the edge member include fibers of silica-alumina, mullite, alumina, silica, and the like. The inorganic fibers A may be bio-soluble fibers. Each of these may be used alone or two or more of these may be used in combination. The inorganic fibers A are preferably alumina. The lower limit of the amount of the inorganic fibers A is preferably about 10% by weight, and more preferably about 20% by weight. The upper limit of the amount of the inorganic fibers A is preferably about 70% by weight, and more preferably about 40% by weight.

Examples of the whiskers include whiskers of alumina, silica, silicon carbide, silica-alumina, glass, potassium titanate, aluminum borate, silicon nitride, boron nitride, and the like.

Examples of the scaly inorganic material or the layered inorganic material include: graphite; smectite clay minerals such as montmorillonite and saponite; layered phosphates such as kaolinite clay minerals and layered zirconium phosphate; layered transition metal oxysalts; layered double hydroxides such as hydrotalcite; layered silicates such as magadiite and kanemite; mica minerals such as white mica, black mica, bronze mica, aluminoceladonite, roscoelite, paragonite, and eastonite; metal phosphates; and the like. Each of the scaly inorganic material and the layered inorganic material may be used alone or two or more of these may be used in combination.

Examples of the inorganic particles A in the edge member include carbides, nitrides, and the like. Specific examples thereof include inorganic powders of silicon carbide, silicon nitride, boron nitride, and the like. The inorganic particles A may be a granulated scaly inorganic material or a granulated layered inorganic material. Each of these may be used alone or two or more of these may be used in combination. The inorganic particles A are preferably silicon carbide particles due to their excellent thermal conductivity. The lower limit of the amount of the inorganic particles A is preferably about 3% by weight, and more preferably about 10% by weight. The upper limit of the amount of the inorganic particles A is preferably about 80% by weight, and more preferably about 60% by weight.

The edge member may further contain a pore-forming agent, if necessary, such as balloons that are fine hollow spheres containing oxide ceramics, spherical acrylic particles, and graphite. The balloons are not particularly limited. Examples thereof include alumina balloons, glass micro balloons, shirasu balloons, fly ash balloons (FA balloons), mullite balloons, and the like. Preferable among these are alumina balloons.

In the honeycomb structure according to the present embodiment, the edge member 10 is formed as follows: a paste having substantially the same composition as the adhesive paste is applied to the vicinity of the end face on the side face of the honeycomb fired body with a metal mask, a nozzle, or the like tool in a substantially quadrangular pillar shape as shown in FIGS. 3A and 3B, and then the paste is dried and solidified.

In the present embodiment, the edge member 10 (solidified product of the paste) having a substantially quadrangular pillar shape with a side X that has substantially the same width as the side A of the side face 110a is disposed. Thus, an adhesive paste applied to the side face of the honeycomb fired body upon the below-mentioned production of a honeycomb structure (honeycomb aggregate) tends to be prevented from leaking toward the end face side of the honeycomb fired body across the edge member 10, and tends to be prevented from sticking to the end face of the honeycomb fired body. As a result, the honeycomb structure is less likely to suffer sealing failure at the end face portions of the honeycomb fired body due to sticking of the adhesive paste to the end face of the honeycomb fired body. In other words, portions (cells) that should not be sealed of the honeycomb fired body are less likely to be sealed or the adhesive paste tends not to stick to the cells that should not be sealed of the honeycomb fired body. Accordingly, the provided honeycomb structure 100 surely serves as a filter for capturing PM in exhaust gas to purify the exhaust gas.

The adhesive paste in the present embodiment is prepared from substantially the same paste as for an edge member, and has substantially the same composition as the edge member. In other words, the pastes for an edge member and for an adhesive layer both have substantially the same composition, but dried and solidified at different timings. The edge member paste is first dried and solidified, and thereby the adhesive paste tends to be prevented from leaking from the edge portion of the honeycomb fired body when honeycomb fired bodies are jointed to form a honeycomb aggregate. Thereafter, the adhesive paste is dried and solidified.

Since the edge member and the adhesive layer have substantially the same composition, problems such as crackings are less likely to occur in the edge member or the adhesive layer due to expansion and shrinkage of the honeycomb fired body, the edge member, and/or the adhesive layer when they are exposed to high temperature in processes such as the regenerating process. In addition, the adhesive paste tends not to stick to the end face of the honeycomb fired body. As a result, the provided honeycomb structure is likely to be highly reliable.

Since the edge member 10 in the present embodiment is a solidified product of the paste containing an inorganic material, the edge member 10 is less likely to disappear even when the honeycomb structure is exposed to high temperature in processes such as the regenerating process. Thus, defects such as space are less likely to occur in a portion where the edge member or the adhesive layer is disposed inside the honeycomb structure 100. In other words, the honeycomb structure tends to prevent defects such as crackings starting from the space inside the edge member or the adhesive layer due to expansion and shrinkage of the honeycomb fired body, the edge member, and/or the adhesive layer when they are exposed to high temperature in processes such as the regenerating process.

The following will describe a method for manufacturing the honeycomb structure according to the present embodiment.

First, silicon carbide powders each having a different average particle diameter as ceramic materials, an organic binder, a plasticizer, a lubricant, water, and the like are mixed to provide a wet mixture for manufacturing a molded body.

The wet mixture is charged into an extrusion-molding apparatus and is extrusion-molded. Thereby, a honeycomb molded body with a predetermined shape is manufactured.

The honeycomb molded body is cut at both ends into a predetermined length with a cutting apparatus, and the cut honeycomb molded body is dried with a drying apparatus. A predetermined amount of a plug material paste that is to be a plug is filled into ends on the gas outlet side of the cells each of which is to have an opening on the end face at the gas inlet side and into ends on the gas inlet side of the cells each of which is to have an opening on the end face of the gas outlet side. Thereby, the cells are sealed. Here, the wet mixture is used as the plug material paste.

As a result of these steps, a cell-sealed honeycomb molded body is manufactured.

Next, the cell-sealed honeycomb molded body is heated to be degreased in a degreasing furnace so that organic substances therein are removed. The degreased cell-sealed honeycomb molded body is put into a firing furnace and fired therein. Thereby, a honeycomb fired body is manufactured.

The aforementioned steps are followed by the steps of: disposing the edge members each having a substantially quadrangular pillar shape with a side X on the side faces of the honeycomb fired bodies each having a side A that is shared with the end face thereof, the side X having substantially the same width as the side A, such that the side X of each edge member is brought close to the side A; applying the adhesive paste to one of the side faces of a first one of the honeycomb fired bodies with the edge members disposed thereon; bonding one of the side faces of a second one of the honeycomb fired bodies to the adhesive paste applied to the one of the side faces of the first one of the honeycomb fired bodies; repeating the disposing, the applying, and the bonding to provide a honeycomb aggregate with the honeycomb fired bodies bonded to each other by interposing the adhesive paste layers; and solidifying the adhesive paste layers to form adhesive layers.

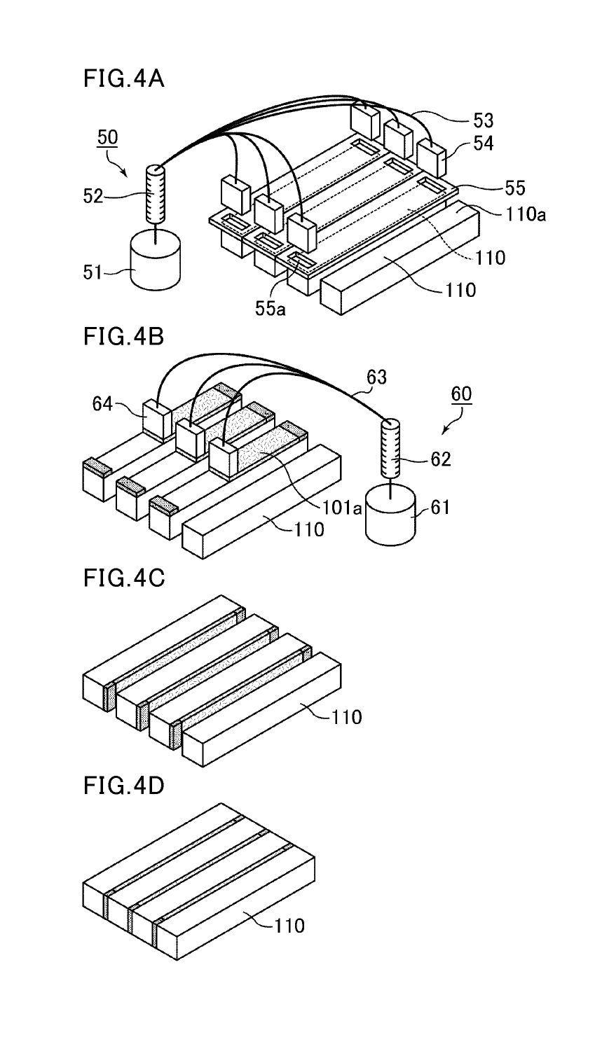

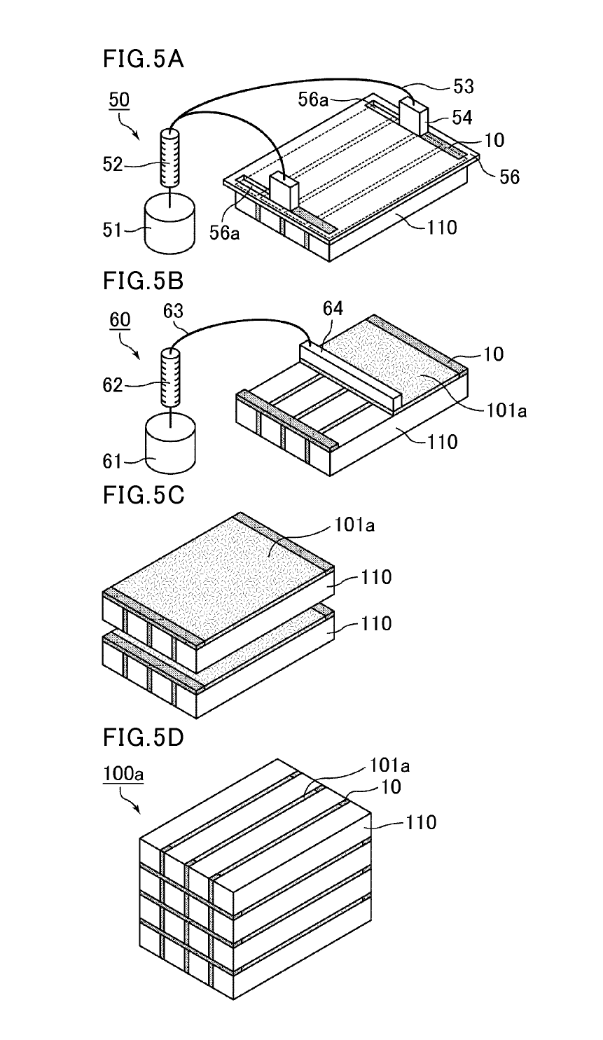

FIGS. 4A to 4D and FIGS. 5A to 5D are schematic explanatory views each showing one embodiment of carrying out the above steps of the present invention.

First, edge members 10 each of which has a substantially quadrangular pillar shape with a side X are disposed on side faces 110a of honeycomb fired bodies 110, each side face having a side A that is shared with an end face 110b of the honeycomb fired body 110 and each side X having substantially the same width as the side A, such that the side X of the edge member 10 is brought close to the side A.

Specifically, four honeycomb fired bodies 110 are aligned at a predetermined distance as shown in FIG. 4A. Metal masks 55 are placed on side faces 110a of the three honeycomb fired bodies 110. Each mask 55 is larger than the side faces 110a, and has openings 55a at positions where the edge members 10 are to be formed. Edge member paste layers to be the edge members 10 are formed (disposed) in the openings 55a of the masks 55, and then dried for a predetermined time period to be solidified. Thereby, the edge members 10 are formed (the disposing of edge members).

As shown in FIG. 4A, an edge member-applying apparatus 50 is prepared that is equipped with a tank 51 for storing an edge member paste, a cylinder 52 for squeezing out the edge member paste, supplying pipes 53, and applying jigs 54. With this apparatus, the edge member paste containing components such as inorganic particles A, inorganic fibers A, an inorganic binder, and an organic binder are applied and the edge member paste layers to be the edge members are formed inside the openings 55a of the masks 55 as mentioned above. Thereafter, the edge member paste layers are heated for from about 30 minutes to about 2 hours at from about 105° C. to about 130° C. to be solidified. Thereby, the edge members 10 are formed.

Each edge member 10 is preferably from about 3 mm to about mm in width along the side Y, and is preferably from about 5 mm to about 10 mm in thickness along the side Z (see FIG. 3B).

As shown in FIG. 4B, an adhesive paste-applying apparatus 60 is prepared that is equipped with a tank 61 for storing an adhesive paste, a cylinder 62 for squeezing out the adhesive paste, supplying pipes 63, and applying jigs 64. With this apparatus, the adhesive paste is applied to form adhesive paste layers 101a on the whole face where no edge member 10 is disposed of the side faces 110a of the honeycomb fired bodies 110.

As shown in FIG. 4C, the three honeycomb fired bodies 110 each with the edge members 10 and the adhesive paste layer formed thereon are rotated about the longitudinal axis by about 90°. Thereby, the face with the edge members 10 disposed and the adhesive paste layer 101a formed thereon of each honeycomb fired body 110 is made to face the side face 110a with no adhesive paste layer and the like formed thereon of the adjacent honeycomb fired body 110.

As shown in FIG. 4D, the honeycomb fired bodies 110 are brought close to each other and are bonded to each other by interposing the adhesive paste layers and the edge members 10. In this step, the adhesive paste 101a leaks toward the upper side face 110a of the honeycomb fired body 110. Thus, the sticking adhesive paste may be scraped out with a scraper (not shown).

As shown in FIG. 5A, a large-area mask 56 having openings 56a at portions where edge members are to be formed is placed on the side faces 110a with no edge member 10 disposed thereon of the four honeycomb fired bodies 110 such that the mask covers the whole surface of the side faces 110a of the honeycomb fired body 110. Then, the edge member paste is applied inside the openings 56a to form edge member paste layers, and the edge member paste layers are heated and dried to be solidified. Thereafter, as shown in FIG. 5B, an adhesive paste 101a is applied in the same manner as shown in FIG. 4B. Thereby, a product with the edge members and the adhesive paste layer formed on the upper face of the bonded four honeycomb fired bodies 110 is produced. In this case, the edge member paste layers are preferably formed such that portions to be edge members 10 are continuously disposed on the whole edge portion of the four-line honeycomb fired bodies as shown in FIGS. 5A and 5B. This is because, owing to such a structure, the edge members 10 are formed on the whole edge portion of the honeycomb fired bodies 110, and thus the adhesive paste is less likely to leak out from the edge portion of the honeycomb fired bodies 110.

In this case, the edge member paste layers to be edge members 10 may be formed only on the side face 110a of each honeycomb fired body 110, and then may be solidified to be the edge members 10.

Next, other four honeycomb fired bodies 110 are processed in the same manner as in the method shown in FIGS. 4A to 4D, and thereby a required number of jointed products are manufactured in which the four honeycomb fired bodies 110 are bonded to each other at the side faces 110a. As shown in FIG. 5C, the jointed product of the four honeycomb fired bodies 110 bonded to each other by interposing the adhesive paste layers 101a and the edge members 10 is placed on and bonded to the previously manufactured jointed product of the four honeycomb fired bodies 110 by interposing the edge members 10 and the adhesive paste layers. Thereby, a honeycomb aggregate is manufactured in which the two jointed products each including the four honeycomb fired bodies 110 are piled up. FIG. 5C shows the case that the edge members are formed not only on the side faces 110a of the honeycomb fired bodies 110 but also on the adhesive layers and/or the edge members between the honeycomb fired bodies 110.

The edge member may not be formed on the adhesive layers and/or the edge members between the honeycomb fired bodies. Even in such a case, the portion where no edge member is formed has a small cross-sectional area. Thus, the adhesive paste is less likely to leak from the opening portion and sealing failure that the adhesive paste sticks to the end faces of the honeycomb fired bodies 110 is less likely to occur; however, the edge members are preferably formed (disposed) even on the adhesive layers and/or the edge members.

As shown in FIG. 5D, the aforementioned steps are repeated and four jointed products each including the four honeycomb fired bodies 110 bonded to each other by interposing the adhesive paste are piled up by interposing the edge members and the adhesive paste to provide a honeycomb aggregate 100a.

In the aforementioned steps of bonding the honeycomb fired bodies 110 to each other and of piling up one jointed product of the four honeycomb fired bodies 110 bonded to each other on another jointed product of the four honeycomb fired bodies 110, the vicinity of each end face of the honeycomb fired bodies 110 is blocked by the edge member 10. Thus, the adhesive paste is not pushed out across the edge member 10 toward the end face side of the honeycomb fired body 110, and problems such as sealing failure is less likely to occur at the end faces due to the adhesive paste sticking to the end faces of the honeycomb fired bodies 110.

In addition, the edge members of the provided honeycomb structure each include an inorganic binder, inorganic fibers A, and inorganic particles A. Thus, the edge members is less likely to disappear even when exposed to high temperature in processes such as the regenerating process, and defects such as crackings due to disappearance of the edge members are less likely to occur inside the adhesive layers and the edge members.

This honeycomb aggregate is heated for about 1 hour at from about 50° C. to about 150° C. so that the adhesive paste layers are dried and solidified to form adhesive layers. Thereby, the honeycomb aggregate is formed into a ceramic block in which the honeycomb fired bodies 110 bonded to each other.

Thereafter, the periphery of the ceramic block is cut with a diamond cutter or the like. Thereby, a substantially round pillar-shaped ceramic block is provided.

A seal material paste is applied to the peripheral surface of the substantially round pillar-shaped ceramic block, and the seal material paste is dried and solidified to form a coating layer.

Here, the seal material paste may be substantially the same as the aforementioned adhesive paste.

As a result of the aforementioned steps, a honeycomb structure is manufactured.

The following will describe the effects of the honeycomb structure and the method for manufacturing a honeycomb structure of the present embodiment.

(1) The edge member of the honeycomb structure according to the present embodiment includes an inorganic material. Thus, the edge member is less likely to disappear and a space tends not to be formed in the edge member and the adhesive layer when the adhesive layer is dried and solidified or upon the regenerating process in the case that the honeycomb structure is used as an exhaust gas purifying filter. As a result, the honeycomb structure of the present embodiment is less likely to suffer defects such as crackings inside the edge members and/or the adhesive layers even when thermal stress is generated in the edge member or the adhesive layer due to expansion and shrinkage of the honeycomb fired body, the edge member, and/or the adhesive layer even when they are exposed to high temperature in processes such as the regenerating process.

(2) In the honeycomb structure according to the present embodiment, the side face that contacts the adhesive layer has the side A shared with the end face of the honeycomb fired body; the edge member has a substantially quadrangular pillar shape with the side X having substantially the same width as the side A; and the edge member is disposed such that the side X is brought close to the end face of the honeycomb fired body. Thus, the honeycomb structure is less likely to suffer sealing failure at the end face portion of the honeycomb fired body due to sticking of the adhesive paste to the end face of the honeycomb fired body across the edge member formed on the honeycomb fired body, in other words, portions (cells) that should not be sealed of the honeycomb fired body are less likely to be sealed and the adhesive paste tends not to stick to the cells that should not be sealed of the honeycomb fired body. As a result, the honeycomb structure of the present embodiment may sufficiently serve as a filter for capturing PM in exhaust gas to purify the exhaust gas.

### Second Embodiment

The following will describe a second embodiment that is one embodiment of the honeycomb structure and the method for manufacturing a honeycomb structure according to the present invention.

The present embodiment shows the case of the honeycomb structure wherein the honeycomb fired body that constitutes the honeycomb structure is made of porous silicon carbide, and the edge member 10 is a spacer (gap-maintaining member) prepared by applying a substance that is usable as an adhesive paste to the main surface of a substantially quadrangular pillar-shaped nonflammable sheet material. This spacer is attached to the vicinity of the end face on the side face 110a of the honeycomb fired body 110A by interposing the adhesive paste, and thereby used as an edge member 10.

A nonflammable sheet material for an edge member 10 is preferably produced from an inorganic fibrous paper or an inorganic filler paper. In particular, it is preferably produced from inorganic fibers B and inorganic particles B.

The inorganic fibrous paper is one mainly containing inorganic fibers B and processed into a sheet shape such as a paper, mat, or felt shape. The inorganic filler paper is one mainly containing inorganic particles B and/or fine inorganic fibers B and processed into a sheet shape.

The inorganic fibers B preferably include at least one selected from alumina, zirconia, alumina-silica, silica, glass, calcium silicate, magnesium silicate, rock wool, glass wool, mineral fibers, and synthetic fibers.

The inorganic particles B preferably include at least one selected from silica, titania, alumina, zirconia, spinel, magnesia, aluminum hydroxide, calcium carbonate, talc, calcium silicate, magnesium silicate, perlite, vermiculite, and diatomite.

Inorganic particles C such as MgO, CaO, and feldspar, organic substances such as woody pulp and organic binders, and inorganic fillers other than the aforementioned inorganic particles B may be added to the inorganic fibers B, the inorganic particles B, or combination of the inorganic fibers B and the inorganic particles B.

The nonflammable sheet material for an edge member 10 preferably has a density of from about 0.8 g/cm³ to about 2.0 g/cm³. A nonflammable sheet material with a density of from about 0.8 g/cm³ to about 2.0 g/cm³ tends to cause a small pressure applied to the side face of the honeycomb fired body at a portion contacting the edge member 10, and thereby the honeycomb fired body tends to be prevented from being damaged.

The nonflammable sheet material for an edge member 10 of this kind is cut into pieces each with a predetermined edge member shape. The adhesive paste described in the first embodiment of the present invention is applied to the main surfaces of these cut sheet materials, and the sheet materials are attached to the vicinity of each end face on the side face 110a of the honeycomb fired body 110A. Thereby, the sheet materials are used as edge members 10.

Also in the present embodiment, the edge member having a side X with substantially the same width as the side of the side face of the honeycomb fired body is disposed. Thus, the adhesive paste tends not to leak to the end face side of the honeycomb fired body across the edge member and tends not to stick to the end face of the honeycomb fired body when the adhesive paste is applied to the side face of the honeycomb fired body in the below-mentioned manufacturing of the honeycomb structure. As a result, the honeycomb structure is less likely to suffer sealing failure at the end face portion of the honeycomb fired body due to the sticking of the adhesive paste to the end face of the honeycomb fired body, in other words, portions (cells) that should not be sealed of the honeycomb fired body are less likely to be sealed and the adhesive paste tends not to stick to the cells that should not be sealed of the honeycomb fired body. Therefore, the honeycomb structure of the present embodiment may sufficiently serve as a filter for capturing PM in exhaust gas to purify the exhaust gas.

Further, the edge member includes a nonflammable inorganic material. Thus, the edge member is less likely to disappear even when exposed to high temperature upon processes such as the regenerating process of the honeycomb structure, and defects such as space tend not to occur in the edge member and/or the adhesive layer inside the honeycomb structure.

As a result, the honeycomb structure tends to prevent defects such as crackings starting from the space inside the edge member or the adhesive layer due to expansion and shrinkage of the honeycomb fired body, the edge member, and/or the adhesive layer when they are exposed to high temperature in processes such as the regenerating process.

The following will describe a method for manufacturing the honeycomb structure of the present embodiment based on the aforementioned description.

In the present embodiment, a honeycomb molded body and a honeycomb fired body are manufactured in substantially the same methods as in the first embodiment of the present invention.

Thereafter, the edge members each having a substantially quadrangular pillar shape with a side X are disposed on the side faces of the honeycomb fired bodies each having a side A shared with the end face, the side X having substantially the same width as the side A, such that the side X of the edge member is brought close to the side A; an adhesive paste is applied to one of the side faces where the edge member is disposed of a first one of the honeycomb fired bodies; one of the side faces of a second one of the honeycomb fired bodies is bonded onto the adhesive paste layer formed on the one of the side faces of the aforementioned first one of the honeycomb fired bodies, and these steps are repeated so that a honeycomb aggregate is manufactured in which the honeycomb fired bodies are bonded to each other by interposing the adhesive paste layer; and the adhesive paste layers are solidified to form adhesive layers.

In the present embodiment, the application of an adhesive paste, the manufacturing of a honeycomb aggregate, and the formation of adhesive layers are performed in the same manner as in the first embodiment of the present invention. Thus, the following will first describe the disposing of an edge member that is performed in a different manner from the first embodiment of the present invention.

In the present embodiment, the nonflammable sheet material for an edge member 10 having the shape of the edge member 10 is attached to the vicinity of the end face on the side face 110a of the honeycomb fired body 110A by interposing the adhesive paste instead of forming the edge member paste layer with a metal mask as shown in FIG. 4A performed in the first embodiment of the present invention.

Here, the bottom of the edge member 10 and the side face 110a of the honeycomb fired body 110 are bonded to each other, and the adhesive strength therebetween is stronger than the force the adhesive paste requires to leak from the edge portion of the honeycomb fired body when the honeycomb fired bodies are jointed to form the honeycomb aggregate. Thus, the adhesive paste does not leak toward the end face of the honeycomb fired body, and thereby the edge member is less likely to be displaced.

At this time, the edge member 10 is less likely to be displaced if the sheet material for an edge member 10 is pressed to be sufficiently bonded to the honeycomb fired body. Further, the sheet material for an edge member 10 may be surely fixed to the side face 110a of the honeycomb fired body 110 by drying and solidifying the adhesive paste after the bonding. The fixed edge member is less likely to be displaced.

Then, the adhesive paste 101a is applied to the whole surface of the portion where no edge member 10 is disposed on the side faces 110a of the honeycomb fired bodies 110, and thereby the adhesive paste layers 101a are formed in the same manner as in the first embodiment of the present invention (as in the same manner shown in FIG. 4B).

Then, the three honeycomb fired bodies 110 with the edge members 10 and the adhesive paste layers formed thereon are rotated about the longitudinal axis by about 90°, and the face with the edge members 10 and the adhesive paste layer 101a formed thereon of each honeycomb fired body 110 is made to face the side face 110a with no adhesive paste layer and the like formed thereon of the adjacent honeycomb fired body 110 in the same manner as in the first embodiment of the present invention (as in the same manner shown in FIG. 4C).

The honeycomb fired bodies 110 are brought close to each other and are bonded to each other by interposing the adhesive paste layers and the edge members 10 in the same manner as in the first embodiment of the present invention (in the same manner shown in FIG. 4D).

Then, the sheet materials for edge members 10 are attached to the side faces 110a of the honeycomb fired bodies 110A by interposing the adhesive paste layers instead of the method of disposing the edge members 10 shown in FIG. 5A of the first embodiment of the present invention. At this time, the sheet materials for edge members 10 are attached to the jointed product of the four honeycomb fired bodies by interposing the adhesive paste layers so that the whole edge portion is continuously covered with the portion to be the edge member 10. As mentioned above, the sheet materials for edge members 10 may be attached only to the side faces 110a of the honeycomb fired bodies 110 by interposing the adhesive paste layers instead of continuously attaching the edge members 10 to the whole edge portion of the honeycomb fired bodies.

Then, other four honeycomb fired bodies 110 are processed in substantially the same manner as mentioned above, and thereby the four honeycomb fired bodies 110 are bonded to each other at the side faces 110a. Thereafter, four jointed product of the four honeycomb fired bodies 110 are piled up, and thereby a honeycomb aggregate 100a is manufactured in substantially the same manner as in the first embodiment of the present invention (in substantially the same manner shown in FIGS. 5C to 5D).

The adhesive paste layers are solidified to provide adhesive layers, the periphery of the honeycomb aggregate 100a is cut, and a coating layer is formed in substantially the same manner as in the first embodiment of the present invention. Thereby, a honeycomb structure is manufactured.

The following will describe the effects of the honeycomb structure and the method for manufacturing a honeycomb structure of the present embodiment.

(1) The edge member of the honeycomb structure according to the present embodiment includes a nonflammable material containing an inorganic material. Thus, the edge member is less likely to disappear and a space tends not to be formed in the adhesive layer upon drying and solidifying the adhesive paste layer or upon the regenerating process in the case that the honeycomb structure is used as an exhaust gas purifying apparatus. As a result, the honeycomb structure may be less likely to suffer defects such as crackings starting from the space inside the edge member or the adhesive layer due to expansion and shrinkage of the honeycomb fired body, the edge member, and/or the adhesive layer when they are exposed to high temperature in processes such as the regenerating process.

(2) In the honeycomb structure of the present embodiment, the side face contacting the adhesive layer has a side A that is shared with the end face of the honeycomb fired body; the edge member has a substantially quadrangular pillar shape with a side X having substantially the same width as the side A; and the edge member is disposed such that the side X is brought close to the end face of the honeycomb fired body. Thus, the adhesive paste does not leak across the edge member and stick to the end face of the honeycomb fired body, and the honeycomb structure is less likely to suffer sealing failure at the end face portion of the honeycomb fired body, in other words, portions (cells) that should not be sealed of the honeycomb fired body are less likely to be sealed, and the adhesive paste tends not to stick to the cells of the honeycomb fired body. As a result, the honeycomb structure may sufficiently serve as a filter for capturing PM in exhaust gas to purify the exhaust gas.

### Third Embodiment

The following will describe a third embodiment that is one embodiment of the honeycomb structure and the method for manufacturing a honeycomb structure according to the present invention.

The present embodiment gives an explanation of the case in which the honeycomb fired body that constitutes the honeycomb structure is made of a porous silicon carbide, and the edge member 10 is integrally formed with the honeycomb fired body by preparing a wet mixture that is produced from the same material as the honeycomb fired body 110, forming in the vicinity of the end face on the side face 110a of the honeycomb molded body 110 in the shape of the edge member, and firing them.

The wet mixture for an edge member 10 may be substantially the same as the constituent material of the honeycomb fired body. The wet mixture is not limited to the same as the constituent material of the honeycomb fired body as long as the edge member can be integrally formed with the honeycomb fired body.

The edge member of the present embodiment is integrally formed with the honeycomb fired body. Thus, the honeycomb structure according to the present embodiment is also described as follows: a honeycomb structure includes: honeycomb fired bodies each having a large number of cells longitudinally disposed in parallel with each other with a cell wall interposed therebetween, and each having side faces and end faces; adhesive layers disposed on the side faces and each adhesive layer bonding the honeycomb fired bodies to each other; and protruding portions integrally formed with the honeycomb fired bodies on edge portions of the side faces, each side face that contacts the adhesive layer having a side A shared with an end face, each protruding portion having a substantially quadrangular pillar shape with a side X having substantially the same width as the side A, and disposed such that the side X is brought close to the end face of the honeycomb fired body.

In the above honeycomb structure, the protruding portion corresponds to the edge member mentioned below.

Examples of the main component of the wet mixture for an edge member include silicon carbide; the main component of the constituent material of the honeycomb structure is not limited to silicon carbide and may be other ceramic materials. Examples of the other ceramic materials include nitride ceramics such as aluminum nitride, silicon nitride, boron nitride, and titanium nitride; carbide ceramics such as zirconium carbide, titanium carbide, tantalum carbide, and tungsten carbide; composites of metal and nitride ceramics; composites of metal and carbide ceramics; and the like.

In addition, examples of the constituent material also include ceramic materials such as silicon-containing ceramics prepared by mixing metal silicon with the aforementioned ceramics and ceramics bound with silicon and silicate compounds.

The wet mixture including the constituent material of the honeycomb structure and the wet mixture for an edge member preferably contain substantially the same main component. In such a case, the edge member is less likely to suffer crackings due to expansion and shrinkage of the honeycomb fired body, edge member, and/or the adhesive layer when they are exposed to high temperature in processes such as the regenerating process.

The main component of the wet mixture for an edge member is particularly preferably silicon carbide or silicon-containing silicon carbide because of their excellent properties such as heat resistance, mechanical strength, and thermal conductivity.

The organic binder that is a component of the wet mixture for an edge member is not particularly limited. Examples thereof include carboxymethyl cellulose, hydroxyethyl cellulose, polyethylene glycol, and the like. The amount of the organic binder is preferably from about 1 part by weight to about 10 parts by weight for 100 parts by weight of the ceramic powders.

The plasticizer and the lubricant used for preparing the wet mixture for an edge member are not particularly limited. Examples of the plasticizer include glycerin and the like. Examples of the lubricant include polyoxy alkylene compounds such as polyoxyethylene alkyl ethers and polyoxypropylene alkyl ethers, and the like.

Specific examples of the lubricant include polyoxyethylene monobutyl ether and polyoxypropylene monobutyl ether.

The wet mixture for an edge member may contain no plasticizer and/or lubricant in some cases.

In addition, a dispersant solution may be used for preparing the wet mixture for an edge member. Examples of the dispersant solution include organic solvents such as water and benzene, alcohols such as methanol, and the like.

Further, the wet mixture for an edge member may contain a forming aid and the like.

The forming aid is not particularly limited, and examples thereof include ethylene glycol, dextrin, fatty acids, fatty acid soaps, polyalcohols, and the like.

If necessary, the wet mixture for an edge member may contain a pore-forming agent such as balloons that are fine hollow spheres containing oxide ceramics, spherical acrylic particles, and graphite.

The balloons are not particularly limited. Examples thereof include alumina balloons, glass micro balloons, shirasu balloons, fly ash balloons (FA balloons), mullite balloons, and the like. Preferable among these are alumina balloons.

Since the wet mixture for a honeycomb fired body is substantially the same as the wet mixture for an edge member, the description thereof is omitted herein. The phrase “substantially the same as” herein means that these wet mixtures contain the same main component. As long as they contain the same main component, the wet mixtures may contain the main component at different ratios and may contain different components other than the main component.

Also in the present embodiment, the edge member having a side X with substantially the same width as the side of the side face of the honeycomb fired body is disposed on the honeycomb fired body. Thus, the adhesive paste does not leak to the end face side of the honeycomb fired body across the edge member of the honeycomb fired body and stick to the end face of the honeycomb fired body when the adhesive paste is applied to the side face of the honeycomb fired body upon production of the honeycomb structure mentioned below. As a result, the honeycomb structure is less likely to suffer sealing failure at the end face portion of the honeycomb fired body due to sticking of the adhesive paste to the end face of the honeycomb fired body, in other words, portions (cells) that should not be sealed of the honeycomb fired body are less likely to be sealed and the adhesive paste tends not to stick to the cells of the honeycomb fired body. Therefore, the honeycomb structure may sufficiently serve as a filter for capturing PM in exhaust gas to purify the exhaust gas.

In addition, the edge member includes substantially the same material as the wet mixture for a honeycomb fired body. Thus, the edge member is less likely to disappear even when exposed to high temperature upon processes such as the regenerating process of the honeycomb structure. As a result, problems such as crackings are less likely to occur inside the edge member or the adhesive layer even when thermal stress occurs in the edge member or the adhesive layer due to expansion and shrinkage of the honeycomb fired body, the edge member, and/or the adhesive layer when they are exposed to high temperature in processes such as the regenerating process.

In the method for manufacturing a honeycomb structure according to the present embodiment, the wet mixture having the aforementioned composition is applied to the vicinity of the end face on the side face of the honeycomb molded body with a mask or the like which is substantially similar to that used in the first embodiment of the present invention, and thereby a wet mixture layer having an edge member shape shown in FIG. 3 is formed. Thereafter, the honeycomb molded body with the wet mixture layer formed thereon is dried, degreased, and fired. Thereby, the honeycomb fired body 110 and the edge member 10 are simultaneously manufactured.

The following will describe a method for manufacturing a honeycomb structure of the present embodiment based on the aforementioned description.

The method for manufacturing a honeycomb structure according to the present embodiment provides a honeycomb structure including: honeycomb fired bodies each having a large number of cells longitudinally disposed in parallel with each other with a cell wall interposed therebetween and each having side faces and end faces; adhesive layers disposed on the side faces and each bonding the honeycomb fired bodies to each other; and edge members each including an inorganic material, the method including: disposing edge members each having a substantially quadrangular pillar shape with a side X on the side faces of the honeycomb molded body having a side A that is shared with an end face of the honeycomb molded body, the side X having substantially the same width as the side A, such that the side X of each edge member is brought close to the side A; firing the honeycomb molded bodies with the edge members disposed thereon to manufacture honeycomb fired bodies with the edge members disposed thereon; forming adhesive paste layers on the portion where no edge member disposed of the honeycomb fired bodies; manufacturing a honeycomb aggregate with the honeycomb fired bodies bonded to each other by interposing the adhesive paste layers; and solidifying the adhesive paste layers to form adhesive layers.

The edge member is disposed on the side face of the honeycomb fired body by the aforementioned firing; here, it is also possible to consider that the aforementioned protruding portion is formed on the side face of the honeycomb fired body.

First, a cell-sealed honeycomb molded body is manufactured in substantially the same manner as in the first embodiment of the present invention.

In the first embodiment of the present invention, the edge member is disposed on the side face of the honeycomb fired body; in the present embodiment, the edge member is disposed on the side face of the honeycomb molded body. The edge member may be disposed in substantially the same manner as in the first embodiment of the present invention.

The edge members having a substantially quadrangular pillar shape with a side X are disposed on the side faces each having a side A that is shared with an end face, the side X having substantially the same width as the side A, such that the side X of each edge member is brought close to the side A.

In the present embodiment, a wet mixture having substantially the same composition as the wet mixture for a honeycomb fired body is applied to the vicinity of the end face on the side face of the honeycomb molded body with a mask and the like in substantially the same manner as in the first embodiment of the present invention (in substantially the same manner as shown in FIG. 4A). Thereby, a wet mixture layer for an edge member having the shape of an edge member shown in FIG. 3 is formed.

The wet mixture layers for edge members each having the shape of an edge member are formed on the side faces of the honeycomb molded bodies by the above method. In other words, all edge members required for manufacturing a honeycomb aggregate are disposed on the side faces of the honeycomb molded bodies at first.

Next, the honeycomb molded bodies each with the wet mixture layers for edge members formed each on the vicinity of the end face on the side face are heated to be degreased so that organic substances therein are removed. Then, the degreased honeycomb molded bodies are transferred to a firing furnace and fired. Thereby, honeycomb fired bodies are manufactured.

As a result of the above steps, honeycomb fired bodies are manufactured in each of which the edge members each produced from substantially the same material as the honeycomb fired body are formed on the side faces.

Thereafter, adhesive paste layers are formed on the portions where no edge member is formed of the honeycomb fired bodies. The adhesive paste layers may be formed in the same manner as in the first embodiment of the present invention (in substantially the same manner as shown in FIG. 4B).

In substantially the same manner as in the first embodiment of the present invention (in the same manner as shown in FIGS. 4C and 4D), four honeycomb fired bodies 110 are bonded to each other by interposing the edge members and the adhesive paste layers. Further, in the same manner as in the first embodiment of the present invention (in the same manner as shown in FIGS. 5A to 5D), honeycomb fired bodies with the edge members including substantially the same material as the honeycomb fired body formed thereon are prepared, and four jointed products of the four honeycomb fired bodies 110 are piled up by interposing the edge members and the adhesive paste layers. Thereby, a honeycomb aggregate 100a is manufactured.

Then, the adhesive paste layers are solidified by heating and drying to form adhesive layers. Thereafter, the periphery of the honeycomb aggregate 100a is cut and a coating layer is formed in substantially the same manner as in the first embodiment of the present invention. Thereby, the manufacture of the honeycomb structure is finished.

Alternatively, a predetermined sheet-shaped dried body or fired body may be preliminarily prepared from the wet mixture for a honeycomb fired body, and the sheet-shaped dried body or fired body may be disposed on the side faces of the honeycomb molded bodies, if necessary, by interposing the wet mixture for a honeycomb fired body, and thereafter the honeycomb molded bodies may be fired.

In the above method, the honeycomb fired bodies and the edge members are simultaneously manufactured. Alternatively, the edge members each of which is a predetermined sheet-shaped fired product may be preliminarily prepared from the wet mixture for a honeycomb fired body, and then these sheet-shaped fired products may be bonded to the vicinity of each end face on the side faces of the honeycomb fired bodies by interposing an adhesive paste. Even in this case, the adhesive paste tends to be prevented from leaking toward the end face of the honeycomb fired body, and the sheet-shaped fired product is less likely to disappear when exposed to high temperature in processes such as the regenerating process. Thus, the honeycomb structure tends to prevent defects such as crackings starting from the space inside the edge member or the adhesive layer due to expansion and shrinkage of the honeycomb fired body, edge member, and/or the adhesive layer when they are exposed to high temperature in processes such as the regenerating process.

The following will describe the effects of the honeycomb structure and the method for manufacturing a honeycomb structure of the present embodiment.

(1) The edge member of the honeycomb structure according to the present embodiment is formed from substantially the same material as the honeycomb fired body. Thus, the edge member is less likely to disappear even when exposed to high temperature upon processes such as the regenerating process in the case that the honeycomb structure is used as an exhaust gas purifying apparatus, and a space tends not to be formed in the adhesive layer. As a result, the honeycomb structure may be less likely to suffer defects such as crackings starting from the space inside the edge member or the adhesive layer due to expansion and shrinkage of the honeycomb fired body, the edge member, and/or the adhesive layer when they are exposed to high temperature in processes such as the regenerating process.

(2) In the honeycomb structure according to the present embodiment, the side face that contacts the adhesive layer has a side A that is shared with the end face; the edge member has a substantially quadrangular pillar shape with a side X having substantially the same width as the side A; and the edge member is disposed such that the side X is brought close to the end face of the honeycomb fired body. Thus, the honeycomb structure is less likely to suffer sealing failure of the honeycomb fired body due to sticking of the adhesive paste to the end face of the honeycomb fired body across the edge member, in other words, portions (cells) that should not be sealed of the honeycomb fired body are less likely to be sealed and the adhesive paste tends not to stick to the cells of the honeycomb fired body. As a result, the honeycomb structure may sufficiently serve as a filter for capturing PM in exhaust gas to purify the exhaust gas.

### Fourth Embodiment

The following will describe a fourth embodiment that is one embodiment of the honeycomb structure and the method for manufacturing a honeycomb structure according to the present invention.

In the present embodiment, the honeycomb fired body that constitutes the honeycomb structure is made of porous silicon carbide, and the edge member 10 is formed from a paste more viscous than the adhesive paste and thus does not flow even when formed on the vicinity of the end face on the side face of the honeycomb molded body.

The edge member paste used in the present embodiment preferably includes inorganic particles B and inorganic fibers B. This is because as follows. The paste of this kind has heat resistance, of course; in the case of containing a large amount of inorganic fibers B, the edge member layer that is formed by solidifying the edge member paste has elasticity. As a result, the honeycomb structure is less likely to suffer problems such as crackings due to expansion and shrinkage of the honeycomb fired body, the edge member, and/or the adhesive layer when they are exposed to high temperature in processes such as the regenerating process, and the whole honeycomb structure has excellent mechanical properties.

The edge member paste preferably has substantially the same composition as the adhesive paste, and preferably has a higher viscosity than the adhesive paste. Hereinafter, the edge member paste (the paste that forms an edge member) is referred to simply as the edge member.

The inorganic fibers B in the edge member preferably include, for example, at least one selected from alumina, zirconia, alumina-silica, silica, glass, calcium silicate, magnesium silicate, mineral fibers, rock wool, glass wool, and synthetic fibers.

The inorganic particles B in the edge member preferably include, for example, at least one selected from silica, titania, alumina, zirconia, spinel, magnesia, aluminum hydroxide, calcium carbonate, talc, calcium silicate, magnesium silicate, perlite, permiculite, and diatomite.

The edge member may contain solids content of the inorganic binder. The edge member of this kind gives excellent adhesiveness between the honeycomb fired bodies in the honeycomb structure. Examples of the inorganic binder include silica sol, alumina sol, and the like. Each of these may be used alone or two or more of these may be used in combination. Preferable among these inorganic binders is silica sol.

The edge member may further contain inorganic particles D and a scaly inorganic material or a layered inorganic material in addition to the inorganic particles B, the inorganic fibers B, and the inorganic binder.

The inorganic particles D are inorganic particles of a compound other than the inorganic particles A, inorganic particles B, and inorganic particles C, and examples thereof include ceramic balloons. Each of these may be used alone or two or more of these may be used in combination.

Examples of the ceramic balloons include alumina balloons, silica balloons, and the like. Balloons of these kinds improve coatability (easy fillingness) of the edge member.

The scaly inorganic material or the layered inorganic material in the edge member is a compound not used as the inorganic fibers A, the inorganic fibers B, the inorganic particles A, the inorganic particles B, the inorganic particles C, and the inorganic particles D. Examples thereof include graphite; smectite clay minerals such as montmorillonite and saponite; layered phosphates such as kaolinite clay minerals and layered zirconium phosphate; layered transition metal oxysalts; layered double hydroxides such as hydrotalcite; layered silicates such as magadiite and kanemite; mica minerals such as white mica, black mica, bronze mica, aluminoceladonite, roscoelite, paragonite, and eastonite; metal phosphates; and the like. These compounds are generally used as particles, and may be used as fibers. Each of these layered inorganic materials may be used alone, or two or more of these may be used in combination.

The edge member may contain an organic substance such as an organic binder. Examples of the organic binder include polyvinyl alcohol, methyl cellulose, ethyl cellulose, carboxymethyl cellulose, and the like. Each of these may be used alone or two or more of these may be used in combination.

The edge member preferably contains: from about 10% to about 70% by weight of the inorganic fibers B; from about 3% to about 80% by weight of the inorganic particles B; from about 1% to about 30% by weight (solids content concentration) of the inorganic binder; and from about 5% to about 20% by weight of a solvent such as water. In the case that the edge member contains the inorganic particles D, the amount thereof is preferably from 0 part by weight to about 40 parts by weight for 100 parts by weight of the inorganic fibers B, the inorganic particles B, and the inorganic binder. In the case that the edge member contains the scaly inorganic material or the layered inorganic material, the amount thereof is preferably from 0 part by weight to about 40 parts by weight.

The edge member is preferably a highly viscous paste, and preferably has a viscosity of from about 60 Pa·s to about 100 Pa·s, more preferably from about 70 Pa·s to about 100 Pa·s, and still more preferably from about 80 Pa·s to about 100 Pa·s. An edge member paste having a viscosity of not less than about 60 Pa·s tends to sufficiently prevent flowing of the adhesive paste. An edge member paste having a viscosity of not more than about 100 Pa·s may not have too high viscosity and may not be difficult to be prepared as a paste, and the paste has no difficulty in forming an edge member.

The adhesive paste preferably has a viscosity of from about 30 Pa·s to about 60 Pa·s, and more preferably from about 40 Pa·s to about 50 Pa·s. An adhesive paste having a viscosity in the above range shows good adhesiveness as an adhesive paste, and it is less likely to leak toward the end face of the honeycomb fired body across the edge member. The viscosities of the adhesive paste and the edge member paste are the values measured with a spiral viscometer type A (PL-1TL, Malcom Co., Ltd.) at 10 rpm by immersing the sensor of the viscometer into the pastes contained in containers.

The edge member of the present embodiment is in a paste state, and is solidified after the honeycomb fired bodies are bonded to each other to form a honeycomb aggregate. Thus, the edge member plays a role of preventing leakage of the adhesive paste to the end face of the honeycomb fired body rather than plays a role of a spacer (gap-maintaining member). In the present embodiment, the edge member and a spacer (gap-maintaining member) are preferably used in combination.

Thus, a spacer is disposed on a position with no edge member disposed thereon on the side face of the honeycomb fired body to separate the honeycomb fired bodies at a predetermined distance before or after the edge member or the adhesive paste layer is disposed.

The edge member 10 may be prepared from substantially the same composition as the material of the adhesive layer; the edge member is required to prevent the fluid adhesive paste from leaking toward the end face of the honeycomb fired body. Thus, the composition of the edge member is preferably changed to be suitable for the above function, and the edge member is preferably adjusted to have high viscosity (for example, from about 60 Pa·s to about 100 Pa·s).

Also in the present embodiment, the edge member having a side X with substantially the same width as a side of the side face of the honeycomb fired body is disposed on the honeycomb fired body. Thus, the adhesive paste tends not to leak toward the end face side across the edge member and tends not to stick to the end face of the honeycomb fired body when the adhesive paste is applied to the side face of the honeycomb fired body in the production of the honeycomb structure mentioned below. As a result, sealing failure is less likely to occur at the end face portion of the honeycomb fired body due to this sticking of the adhesive paste to the end face of the honeycomb fired body, in other words, portions (cells) that should not be sealed of the honeycomb fired body are less likely to be sealed and the adhesive paste tends not to stick to the cells of the honeycomb fired body. Therefore, the honeycomb structure may sufficiently serve as a filter for capturing PM in exhaust gas to purify the exhaust gas.

Since the edge member contains an inorganic material, the edge member is less likely to disappear even when exposed to high temperature upon processes such as the regenerating process of the honeycomb structure. Thus, the honeycomb structure tends to prevent problems such as crackings inside the edge member or the adhesive layer due to expansion and shrinkage of the honeycomb fired body, the edge member, and/or the adhesive layer when they are exposed to high temperature in processes such as the regenerating process.

The following will describe a method for manufacturing the honeycomb structure of the present embodiment based on the above description.

First, honeycomb fired bodies are manufactured in substantially the same manner as in the first embodiment of the present invention.

Then, the edge members each having a substantially quadrangular pillar shape with a side X are disposed on the side faces each having a side A that is shared with the end face, the side X having substantially the same width as the side A, such that the side X is brought close to the side A; the adhesive paste is applied to one of the side faces with the edge members disposed thereon of a first one of the honeycomb fired bodies; one of the side faces of a second one of the honeycomb fired bodies is bonded to the adhesive paste applied on the one of the side faces of the above first one of the honeycomb fired bodies; the above steps are repeated so that the honeycomb fired bodies are bonded to each other by interposing the adhesive paste layers to form a honeycomb aggregate; and the adhesive paste layers are solidified to form adhesive layers.

The disposing of the edge member, the application of the adhesive paste, the manufacturing of the honeycomb aggregate, and the formation of the adhesive layers are performed in substantially the same manner as in the first embodiment of the present invention except that the edge member paste is a highly viscous paste that contains the inorganic particles B, the inorganic fibers B, the inorganic binder, and the like, that has a viscosity of from about 60 Pa·s to about 100 Pa·s, that is applied in the shape shown in FIGS. 3A and 3B, and that is formed into the edge member 10 without being dried and solidified. Since the formed edge member is a paste more viscous than the adhesive paste, it also serves as an adhesive, and thus the honeycomb fired bodies are likely to be well bonded to each other.

On the side face of the honeycomb fired body is also disposed a spacer (gap-maintaining member) for adjusting the distance between the honeycomb fired bodies in addition to the paste as an edge member.

Next, the periphery of the honeycomb aggregate is cut and a coating layer is formed in substantially the same manner as in the first embodiment of the present invention. Thereby, a honeycomb structure is manufactured.

The following will describe the effects of the honeycomb structure and the method for manufacturing a honeycomb structure according to the present embodiment.

(1) The edge member of the honeycomb structure according to the present embodiment contains the inorganic material. Thus, the edge member is less likely to disappear and a space tends not to be formed in the adhesive layer even when exposed to high temperature upon drying and solidifying the adhesive paste layer or in processes such as the regenerating process in the case that the honeycomb structure is used as an exhaust gas purifying apparatus. As a result, the honeycomb structure may be less likely to suffer defects such as crackings starting from the space inside the edge member and/or the adhesive layer due to thermal stress generated by expansion and shrinkage of the honeycomb fired body, the edge member, and/or the adhesive layer when they are exposed to high temperature in processes such as the regenerating process.

(2) In the honeycomb structure according to the present embodiment, the side face that contacts the adhesive layer has a side A shared with the end face; the edge member has a substantially quadrangular pillar shape with a side X having substantially the same width as the side A; and the edge member is disposed such that the side X is brought close to the end face. Thus, sealing failure is less likely to occur at the end face portion of the honeycomb fired body due to sticking of the adhesive paste across the edge member to the end face of the honeycomb fired body, in other words, portions (cells) that should not be sealed of the honeycomb fired body are less likely to be sealed and the adhesive paste tends not to stick to the cells of the honeycomb fired body. As a result, the honeycomb structure may sufficiently serve as a filter for capturing PM in exhaust gas to purify the exhaust gas.

The following will describe examples that disclose the first to fourth embodiments of the present invention in more detail. Here, the present invention is not limited to these examples.

### Example 1

### Manufacturing of Honeycomb Fired Body

Silicon carbide coarse powder having an average particle diameter of 22 μm (52.8% by weight) and silicon carbide fine powder having an average particle diameter of 0.5 μm (22.6% by weight) were mixed to provide a mixture. The obtained mixture was mixed and kneaded with acryl resin (2.1% by weight), an organic binder (methyl cellulose, 4.6% by weight), a lubricant (UNILUB, NOF Corp., 2.8% by weight), glycerin (1.3% by weight), and water (13.8% by weight) to provide a wet mixture. Then, the wet mixture was extrusion-molded to provide a raw honeycomb molded body having substantially the same shape as shown in FIG. 2A and cells not sealed.

The raw honeycomb molded body was dried with a microwave drying apparatus to provide a dried honeycomb molded body. A paste (wet mixture) having the same composition as the raw molded body was filled into predetermined cells, and again dried with a drying apparatus.

The dried honeycomb molded body was degreased at 400° C., and then fired for 3 hours at 2200° C. under normal pressure argon atmosphere. Thereby, a honeycomb fired body made of a silicon carbide sintered body was manufactured with a porosity of 45%, an average particle diameter of 15 μm, a size of 34.3 mm×34.3 mm×150 mm, the number of cells (cell density) of 300 pcs/inch², and a cell wall thickness of 0.25 mm (10 mil).

### (Preparation of Adhesive Paste)

Alumina fibers having an average fiber length of 20 μm (30% by weight), silicon carbide particles having an average particle diameter of 0.6 μm (21% by weight), silica sol (15% by weight, solids content concentration: 30% by weight), carboxymethyl cellulose (5.6% by weight), and water (28.4% by weight) were mixed and kneaded to provide an adhesive paste.

### (Preparation of Edge Member Paste)

An edge member paste used here was one having the same composition as the aforementioned adhesive paste.

### (Bonding of the Honeycomb Fired Bodies)

A honeycomb aggregate was prepared in the same steps and methods as shown in FIGS. 4A to 4D and FIGS. 5A to 5D.

As shown in FIG. 4A, masks 55 and an edge member-applying apparatus 50 equipped with applying jigs 53 were prepared, and the edge member paste was applied and filled into openings 55a of the masks 55. Thereby, paste layers for edge members 10 each having a substantially quadrangular pillar shape and a side X were formed on the side faces 110a of the three honeycomb fired bodies 110 each having a side A that is shared with the end face of each honeycomb fired body 110, the side X having substantially the same width as the side A, such that the side X of each edge member 10 was brought close to the side A. Then, the paste layers for the edge members 10 were heated for 1 hour at 110° C. to be dried and solidified.

Each of the edge members 10 formed by the above step was 34.3 mm in length along the side X, 8 mm in width along the side Y, and 1.0 mm in thickness along the side Z (see FIG. 3B).

As shown in FIG. 4B, the adhesive paste 101a was applied to the portions with no edge member 10 formed thereon on the side faces 110a of the honeycomb fired bodies 110.

As shown in FIG. 4C, the honeycomb fired bodies 110 were rotated about the longitudinal axis by 90°. As shown in FIG. 4D, the honeycomb fired bodies were bonded to each other by interposing the adhesive paste and the edge member. The adhesive paste leaking to the upper face of the honeycomb fired body was scraped out.

As shown in FIG. 5A, a mask 56 is placed on the honeycomb fired bodies, and the edge member paste was applied to and filled into the portions with no edge member 10 disposed thereon on the side faces 110a of the honeycomb fired bodies through openings 56a of the mask. The paste was heated for 1 hour at 110° C. to be dried and solidified. Thereby, edge members 10 were formed. As shown in FIG. 5B, the adhesive paste was applied between the edge members 10, and thereby an adhesive paste layer 101a was formed. As a result, a jointed product of four honeycomb fired bodies 110 bonded to each other at the side faces 110a was prepared.

As shown in FIG. 5C, another jointed product of four honeycomb fired bodies 110 bonded to each other at the side faces 110a was disposed on and bonded to the jointed product of the four honeycomb fired bodies 110 placed below.

The same steps were repeated as mentioned in Embodiment 1, and the four jointed products each including the four honeycomb fired bodies 110 bonded to each other by interposing the adhesive paste layers were piled up. Thereby, a honeycomb aggregate 100a was manufactured.

This honeycomb aggregate 100a was heated at 150° C. so that the adhesive paste layers were solidified to be adhesive layers. Thereby, a ceramic block was manufactured (see FIG. 5D).

At that time, each adhesive paste layer had a thickness (the distance between the honeycomb fired bodies) of 1.0 mm that is the same as the thickness of each edge member 10.

Here, the adhesive paste had a viscosity of 49 Pa·s.

### (Cutting of Periphery and Formation of Coating Layer)

The periphery of the ceramic block was cut into a round pillar shape with a diamond cutter.

A seal material paste made of the same material as the adhesive paste was applied to the periphery of the cut ceramic block to form a seal material paste layer with a thickness of 0.2 mm. This seal material paste layer was dried at 120° C. Thereby, a round pillar-shaped honeycomb structure was manufactured with a coating layer formed on the periphery and a size of 132.5 mm in diameter×150 mm in length.

### Example 2

Honeycomb fired bodies were manufactured and an adhesive paste was prepared in the same manner as in Example 1.

### (Preparation of Sheet Material for Edge Member)

Glass fibers as a main component, woody pulp, feldspar, and aluminum hydroxide were put into water and stirred to form slurry. The slurry was subjected to a sheet-forming process, and then was dehydrated to be sheets.

These sheets were dried to be 1.0-mm thick sheets.

The sheets were punched with a die. Thereby, sheets for edge members were manufactured each with a length of 34.3 mm, a width of 8 mm, and a thickness of 1.0 mm.

### (Bonding of the Honeycomb Fired Bodies)

The adhesive paste prepared in the same manner as in Example 1 was applied to one main surface of each of the sheets for edge members. Then, the sheets were attached to the side faces 110a at the vicinity of the end faces of the honeycomb fired bodies 110 as shown in FIG. 3A. Thereby, edge members 10 were formed.

An adhesive paste layer was formed at a portion with no edge member 10 formed thereon in the same manner as in Example 1. Then, the adhesive paste was also applied to the upper faces of the edge members 10. Thereafter, four honeycomb fired bodies were bonded to each other by interposing the adhesive paste and the edge members as shown in FIG. 4D.

The edge members 10 were attached to the side faces 110a of other honeycomb fired bodies 110 by the above method. Then, the adhesive paste was applied to the edge members 10 to form adhesive paste layers. The honeycomb fired bodies 110 with the adhesive paste layers and the edge members formed thereon were bonded to each other to form three jointed products each including four honeycomb fired bodies bonded to each other by interposing the edge members 10 and the adhesive paste layers. As shown in FIG. 5C, these products were bonded to each other by interposing the edge members 10 and the adhesive paste layers in the same manner as in Example 1. Thereby, a ceramic block was manufactured. Here, the adhesive paste had a viscosity of 49 Pa·s.

### (Cutting of Periphery and Formation of Coating Layer)

The periphery of the ceramic block was cut and a coating layer was formed in the same manner as in Example 1. Thereby, a round pillar-shaped honeycomb structure was manufactured with a size of 132.5 mm in diameter×150 mm in length.

### Example 3

Cell-sealed honeycomb molded bodies were manufactured in the same manner as in Example 1.

The wet mixture for manufacturing honeycomb molded bodies was manufactured, and this wet mixture was applied to the side faces of the honeycomb molded bodies in the vicinity of the end faces by using the same mask 55 as in Example 1. Then, the wet mixture was dried and solidified to be a solidified product of wet mixture layers each having a shape of the edge member 10 as shown in FIGS. 3A and 3B. This step was repeated several times, and thereby solidified products of the wet mixture layers were formed on the side faces of the honeycomb molded bodies. In each honeycomb molded body, the number of the side faces on which the solidified products of the wet mixture layers were formed depends on the position of the honeycomb fired body in the honeycomb aggregate 100a (see FIG. 5D). In the case that the honeycomb fired body is positioned at an internal portion of the honeycomb aggregate 100a, the solidified products of the wet mixture layers are required to be formed on all of the four side faces of the honeycomb molded body. In the case that the honeycomb fired body is positioned at an outer portion, the solidified products of the wet mixture layers are required to be formed on three or two side faces of the honeycomb molded body.

Thereafter, degreasing and firing were performed in the same manner as in Example 1, and the edge members produced from the same material as the honeycomb fired body were formed on the side faces in the vicinity of the end faces. Thereby, a honeycomb fired body made of a silicon carbide sintered body was manufactured with a porosity of 44%, an average pore diameter of 16 μm, a size of 34.3 mm×34.3 mm×150 mm, the number of cells (cell density) of 300 pcs/inch², and a cell wall thickness of 0.25 mm (10 mil). The edge members 10 each were 34.3 mm in length along the side X, 8 mm in width along the side Y, and 1.0 mm in thickness along the side Z.

An adhesive paste was prepared and the adhesive paste layers were formed in the same manner as in Example 1, and a honeycomb aggregate 100a was manufactured in the same manner as in Example 1. The honeycomb aggregate 100a was heated so that the adhesive paste layers were solidified to form adhesive layers. Thereby, a ceramic block was manufactured.

Thereafter, the periphery of the ceramic block was cut and a coating layer was formed in the same manner as in Example 1. Thereby, a round pillar-shaped honeycomb structure was manufactured with a size of 132.5 mm in diameter×150 mm in length. Here, the adhesive paste had a viscosity of 49 Pa·s.

### Example 4

In the same manner as in Example 1, honeycomb fired bodies were manufactured and an adhesive paste was prepared.

### (Preparation of Edge Member Paste)

Alumina fibers having an average fiber length of 20 μm (35% by weight), silicon carbide particles having an average particle diameter of 0.6 μm (21% by weight), silica sol (15% by weight, solids content concentration: 30% by weight), carboxymethyl cellulose (5.6% by weight), and water (18.5% by weight) were mixed and kneaded to provide a edge member paste. This edge member paste had a viscosity of 81 Pa·s.

The edge member paste prepared as mentioned above was applied to the side faces of the honeycomb fired bodies in the vicinity of the end faces to form paste layers (edge members). Here, the paste was neither heated nor solidified. Then, in the same manner as in Example 1, an adhesive paste was prepared and applied, a honeycomb aggregate was manufactured, adhesive layers were formed, and a honeycomb block was manufactured. Thereafter, the periphery of the ceramic block was cut and a coating layer was formed in the same manner as in Example 1. Thereby, a round pillar-shaped honeycomb structure was manufactured with a size of 132.5 mm in diameter×150 mm in length. Here, the adhesive paste has a viscosity of 49 Pa·s.

### Comparative Example 1

First, honeycomb fired bodies were manufactured and an adhesive paste was prepared in the same manner as in Example 1.

### (Preparation of Edge Member Paste)

Alumina fibers having an average fiber length of 20 μm (25% by weight), silicon carbide particles having an average particle diameter of 0.6 μm (21% by weight), silica sol (15% by weight, solids concentration: 30% by weight), carboxymethyl cellulose (5.6% by weight), and water (50% by weight) were mixed and kneaded to provide an edge member paste. This edge member paste had a viscosity of 56 Pa·s.

The edge member paste prepared as mentioned above was applied to the side faces of the honeycomb fired bodies in the vicinity of the end faces to form paste layers (edge members). Here, the paste layers were neither heated nor solidified. Then, the prepared adhesive paste was applied, a honeycomb aggregate was manufactured, adhesive layers were formed, and a ceramic block was manufactured in the same manner as in Example 1. Thereafter, the periphery of the ceramic block was cut and a coating layer was formed in the same manner as in Example 1. Thereby, a round pillar-shaped honeycomb structure was manufactured with a size of 132.5 mm in diameter×150 mm in length. The adhesive paste had a viscosity of 49 Pa·s.

### Comparative Example 2

First, honeycomb fired bodies were manufactured and an adhesive paste was prepared in the same manner as in Example 1.

### (Preparation of Edge Member Sheet)

In the same manner as in Example 2, spacers were manufactured each with a length of 8.0 mm, a width of 5.0 mm, and a thickness of 1.0 mm.

### (Bonding of the Honeycomb Fired Bodies)

No edge member was formed on the side faces of the honeycomb fired bodies, and the adhesive paste was applied to the whole surface of the side faces of the honeycomb fired bodies to form adhesive paste layers.

Then, the spacer (gap-maintaining member) prepared above was attached to the vicinity of each of the four corners of the side faces with the adhesive paste layer formed thereon. Specifically, each spacer was attached such that the shortest distances between each side forming the corner of the side face of the honeycomb fired body and each near and parallel side of the spacer were 4.5 mm.

Except that the adhesive paste layer was formed on the whole surface of the side faces of the honeycomb fired bodies and the spacers were attached to the side faces in the above manner, the ceramic block was manufactured, the periphery of the ceramic block was cut, and a coating layer was formed in the same manner as in Example 1. Thereby, a round pillar-shaped honeycomb structure was manufactured with a size of 132.5 mm in diameter×150 mm in length. The adhesive paste had a viscosity of 49 Pa·s.

### (Evaluation of Leakage of Adhesive Paste)

In each of the examples and the comparative examples, whether or not the adhesive paste leaked across the edge member was visually observed when the honeycomb aggregate was manufactured by applying the adhesive paste to the honeycomb fired bodies with the edge members formed thereon and bonding the honeycomb fired bodies having the adhesive paste layers and the edge members.

### (Evaluation of Sealing Failure on End Face of Honeycomb Structure)

In each of the examples and the comparative examples, whether or not the cells that should not be sealed were sealed in the honeycomb structure (whether or not the honeycomb structure had a cell without light leakage) was checked with a light leakage detector. The case that a cell that should not be sealed did not cause light leakage was regarded as sealing failure; while the case that a cell that should not be sealed caused light leakage was regarded as good sealing.

Light leakage observation was performed as follows: irradiating one end face of the honeycomb structure with light from the light source of the light leakage detector; projecting the light leaked out through the cells on a display with a camera; and visually observing whether or not light leaked from a cell that should not be sealed.

The honeycomb structures manufactured in Examples 1 to 4 did not suffer sealing failure and leakage of the adhesive paste.

In contrast, in Comparative Example 1 where the edge member paste had a low viscosity, the adhesive paste leaked out and sealing failure occurred. In Comparative Example 2 where the spacers were disposed on only the four corners of the honeycomb fired body in a manner similar to the conventional spacers (gap-maintaining members), the adhesive paste leaked out because the honeycomb structure had no function of preventing leakage, and sealing failure occurred.

### Fifth Embodiment

The following will describe a fifth embodiment that is one embodiment of the honeycomb structure and the method for manufacturing a honeycomb structure of the present invention referring to the drawings.

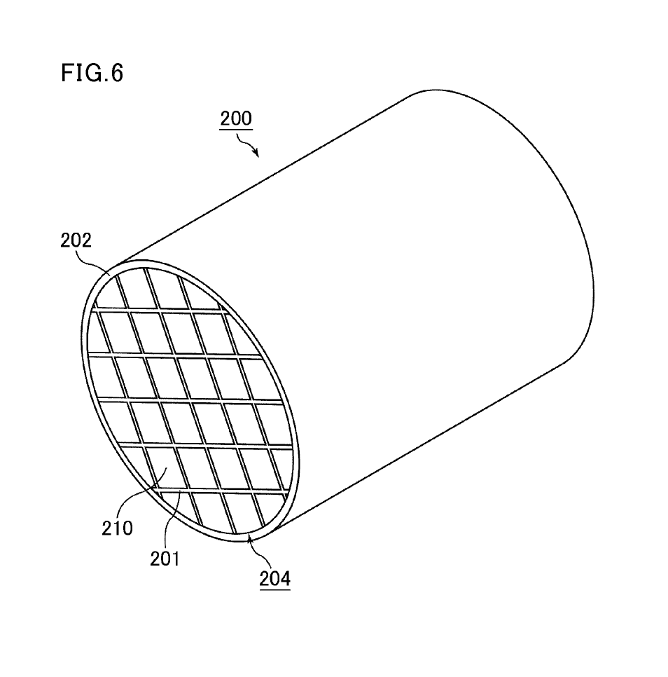

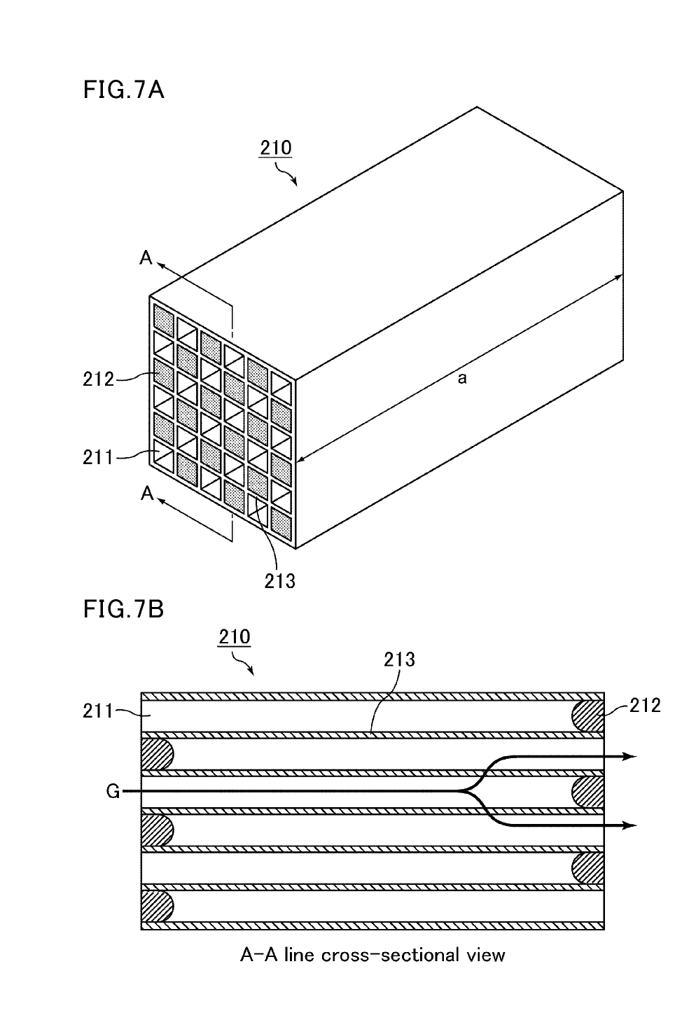

FIG. 6 is a schematic perspective view showing one example of the honeycomb structure according to the fifth embodiment of the present invention. FIG. 7A is a schematic perspective view showing one example of the honeycomb fired body that constitutes the honeycomb structure according to the fifth embodiment of the present invention, and FIG. 7B is an A-A line cross-sectional view showing the honeycomb fired body shown in FIG. 7A.

The honeycomb structure 200 shown in FIG. 6 includes 36 pieces of honeycomb fired bodies 210 each having the shape shown in FIGS. 7A and 7B and bonded to each other by interposing adhesive layers 201 to form a ceramic block 204, and a coating layer 202 was formed on the periphery of the ceramic block 204. Here, the ceramic block 204 is cut to have the shape shown in FIG. 6 after the honeycomb fired bodies 210 are bonded to each other.

Each honeycomb fired body 210 that constitutes the honeycomb structure 200 has a large number of cells 211 disposed in parallel in the longitudinal direction (the direction indicated by a in FIG. 7A) with cell walls 213 interposed therebetween substantially similarly to the honeycomb fired body 110 shown in FIGS. 2A and 2B, and either end of each cell 211 is sealed with a plug 212. Thus, exhaust gas G flowing into one cell 211 having an opening on one end face always passes through a cell wall 213 that separates the cell 211 from the adjacent cell, and then flows out from another cell 211 having an opening on the other end face.

As a result, the cell wall 213 serves as a filter for capturing PM and the like matter.

In the honeycomb structure 200 shown in FIG. 6, edge members and adhesive layers are disposed between the honeycomb fired bodies, and a coating layer is disposed on the periphery of the honeycomb structure similarly to the first embodiment of the present invention. The material, shape, position, and the like of the edge member may be the same as those mentioned in the first to fourth embodiments of the present invention; thus, the description about the edge member is omitted here.

The honeycomb structure according to the fifth embodiment of the present invention is manufactured by a method different from in the first embodiment of the present invention; thus, the following will describe the method of the present embodiment.

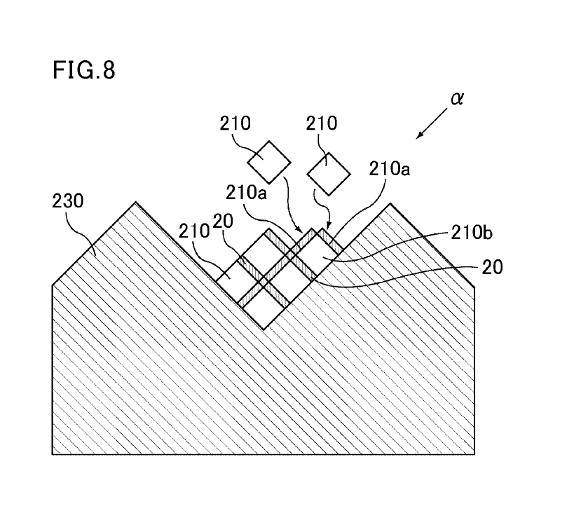

FIG. 8 is a schematic cross-sectional view showing the state of forming edge members and adhesive paste layers with a stage having a V-shaped profile.

As shown in FIG. 8, a stage 230 with the upper portion having a V-shaped profile for diagonally stacking the honeycomb fired bodies 210 is prepared, and the honeycomb fired bodies 210 are diagonally stacked thereon. The side face 210a of the honeycomb fired body 210 has a rectangular shape with a side A that is shared with the end face 210b and a side B that is perpendicular to the side A (see FIGS. 3A and 3B), and two side faces 210a are placed upward.

In the present embodiment, two edge members 20 are formed on each of these two upward side faces 210a with the edge member-applying apparatus 50 shown in FIGS. 4 and 5.

Each of the two edge members 20 formed has a substantially quadrangular pillar shape similarly to the edge member 10 shown in FIG. 3, and has a side X with the same length as the side A of the side face 210a, a side Y along the width direction, and a side Z along the thickness direction. The XY face contacts the side face 210a, and each side X is brought close to the end face 210b of the honeycomb fired body 210.

Next, the adhesive paste is applied to the portions with no edge member 20 formed thereon of the side faces 210a with an adhesive paste-applying apparatus 60 and thereby adhesive paste layers are formed.

Then, other honeycomb fired bodies 210 are stacked on the adhesive paste layers and the edge members 20 formed on the side faces of the honeycomb fired body 210. The step of forming the adhesive paste layers and the edge members 20 on the side faces 210a and this step are repeated, and thereby a honeycomb aggregate is manufactured that includes 36 pieces of the honeycomb fired bodies 210 with the adhesive paste layers and the edge members 20 disposed therebetween.

The honeycomb aggregate is heated for about one hour at from about 50° C. to about 150° C. and thus the adhesive paste layers are solidified to be adhesive layers. The periphery of the honeycomb aggregate is cut with a diamond cutter and a substantially round pillar-shaped ceramic block is manufactured. A seal material paste is applied to the periphery of the substantially round pillar-shaped ceramic block, and then the seal material paste is dried and solidified to be a coating layer. Thereby, the manufacturing of the honeycomb structure is finished.

The present embodiment shows the same effects as the first embodiment of the present invention.

### Sixth Embodiment

The following will describe the sixth embodiment that is one embodiment of the present invention.

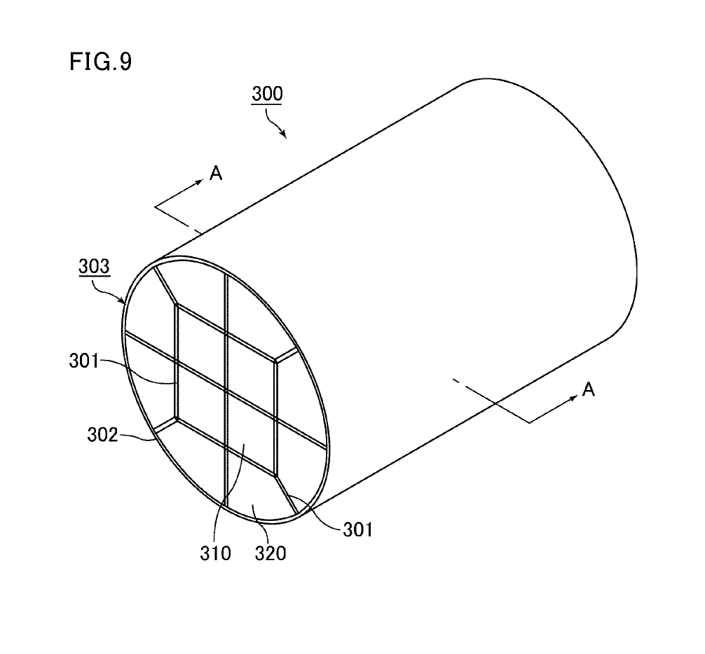

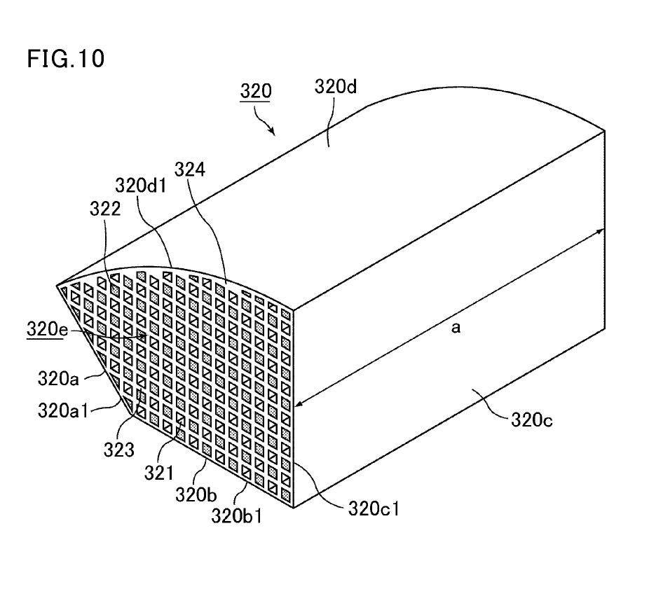

FIG. 9 is a schematic perspective view showing one example of the honeycomb structure according to the present embodiment. FIG. 10 is a schematic perspective view showing one example of the honeycomb fired body disposed on the periphery of the honeycomb structure according to the present embodiment.

The honeycomb structure 300 shown in FIG. 9 is made of porous silicon carbide. Honeycomb fired bodies 310 each having the same structure as the honeycomb fired body 110 shown in FIGS. 2A and 2B are disposed on the center portion, and honeycomb fired bodies 320 each having a substantially fan shape in the direction perpendicular to the longitudinal direction as shown in FIG. 10 are disposed on the peripheral portion.

These honeycomb fired bodies 310 and honeycomb fired bodies 320 are bonded to each other by interposing the adhesive layers 301 to form a ceramic block 303, and a coating layer 302 is formed on the periphery of the ceramic block 303.

Each honeycomb fired body 320 shown in FIG. 10 includes a large number of cells 321 disposed in parallel in the longitudinal direction (the direction indicated by a in FIG. 7A) with cell walls 323 interposed therebetween, and either end of each cell 321 is sealed with a plug material 322. Thus, exhaust gas G flowing into one cell 321 having an opening on one end face always passes through a cell wall 323 that separates the cell 321 from the adjacent cell, and then flows out from another cell 321 having an opening on the other end face. As a result, the cell wall 323 serves as a filter for capturing PM and the like matter.

Each honeycomb fired body 310 also has the same function.

The difference between the honeycomb structure 300 and the honeycomb structure 100 according to the first embodiment of the present invention shown in FIG. 1 is that the honeycomb fired bodies 320 disposed on the peripheral portion are not formed by cutting, but formed by using the honeycomb fired bodies each having an outside wall 324 on the periphery thereof and cells 321 therein as shown in FIG. 10. The peripheral portion of the honeycomb structure is formed from multiple honeycomb fired bodes 320 (specifically, 8 pieces of honeycomb fired bodies) each having substantially the same shape.

As shown in FIG. 10, the end face 320e of the honeycomb fired body 320 is a substantially fan-shaped unit surrounded by three sides 320a1, 320b1, and 320c1, each shared with an end face and a side face of the honeycomb fired body 320, and one arc 320d1. Two angles each formed by two of these three sides (the angle formed by the side 320b1 and the side 320c1, and the angle formed by the side 320a1 and the 320b1) are about 90° and about 135°, respectively. Thus, the substantially round pillar-shaped honeycomb structure 300 is formed by bonding eight honeycomb fired bodies 320 around the four substantially quadrangular pillar-shaped honeycomb fired bodies 310 by interposing the edge members 30 and the adhesive layers 301.

The edge member 30 is the same as the edge member 10 described in the first embodiment of the present invention except its size. With respect to the honeycomb fired bodies 310, the edge members 30 are disposed on the side faces of the honeycomb fired body 320 shown in FIG. 10 such that the side X of each edge member 30 is brought close to the side A of the honeycomb fired body 310 shared with the end face of the honeycomb fired body 320 in the same manner as in the honeycomb fired body 110 shown in FIGS. 2A and 2B.

With respect to the honeycomb fired body 320, six edge members 30 each having a different size are disposed on the honeycomb fired body 320 such that the bottom face of each edge member 30 contacts the side faces 320a, 320b, and 320c of the honeycomb fired body 320, and that the side X of each edge member 30 is brought close to the side 320a1, the side 320b1, or the side 320c1. The side X of each edge member 30 has the same length as the side 320a1, the side 320b1, or the side 320c1 of the honeycomb fired body 320.

Thus, the adhesive paste is less likely to leak out across the edge member 20 of the honeycomb fired body to stick to the end face of the honeycomb fired body when applied to the side face of the honeycomb fired body in the below-mentioned production of the honeycomb structure. Thereby, sealing failure is less likely to occur at the end face portion of the honeycomb fired body due to sticking of the adhesive paste to the end face of the honeycomb fired body, in other words, portions (cells) that should not be sealed of the honeycomb fired body are less likely to be sealed and the adhesive paste tends not to stick to the cells of the honeycomb fired body. As a result, the honeycomb structure 300 may sufficiently serve as a filter for capturing PM in exhaust gas to purify the exhaust gas.

The material, shape, position (arrangement), and the like of the edge member may be the same as in the first to fourth embodiments of the present invention; thus, the description thereof are omitted. Usage instruction for the edge member is described in the below-mentioned production method.

The following will describe a method for manufacturing the honeycomb structure according to the present embodiment.

In substantially the same manner as in the first embodiment of the present invention, a wet mixture for manufacturing a honeycomb molded body is manufactured; the wet mixture is charged into an extrusion-molding apparatus and extrusion-molded; both ends of the honeycomb molded body are cut into a predetermined length with a cutting apparatus; and the cut honeycomb molded body is dried with a drying apparatus. Then, a predetermined amount of a seal material paste to be a plug prepared from the wet mixture is charged into gas flow-out ends of cells that are to have an opening on the gas-inlet end face and gas flow-in ends of cells that are to have an opening on the gas-outlet end face. Thereby, cells are sealed.

A cell-sealed honeycomb molded body is manufactured through these steps.

The cell-sealed honeycomb molded body is heated and degreased so that organic substances therein are removed, and then transferred to a firing furnace and fired. Thereby, a honeycomb fired body is manufactured.

Edge members each having a substantially quadrangular pillar shape with a side X are formed and disposed on the side faces each having a side A and the like shared with the end face of the honeycomb fired bodies 310 and 320, the side X having substantially the same width as the side A and the like, such that the side X of each edge member is brought close to the side A and the like; the honeycomb fired bodies each with the edge members disposed thereon are bonded to each other by interposing the edge members, and thereby a honeycomb jointed body with the honeycomb fired bodies jointed to each other by interposing the edge members is manufactured; a jointed body-housing container is prepared with a size such that a predetermined gap is formed between the honeycomb jointed body contained therein and the jointed body-housing container; the honeycomb jointed body is put into the jointed body-housing container and the predetermined gap is formed between the honeycomb jointed body and the jointed body-housing container; the adhesive paste is filled into the gaps between the honeycomb fired bodies of the honeycomb jointed body and the gap between the honeycomb jointed body and the jointed body-housing container to form adhesive paste layers and a coating layer in/on the honeycomb jointed body; and the adhesive paste layers are solidified to be adhesive layers.

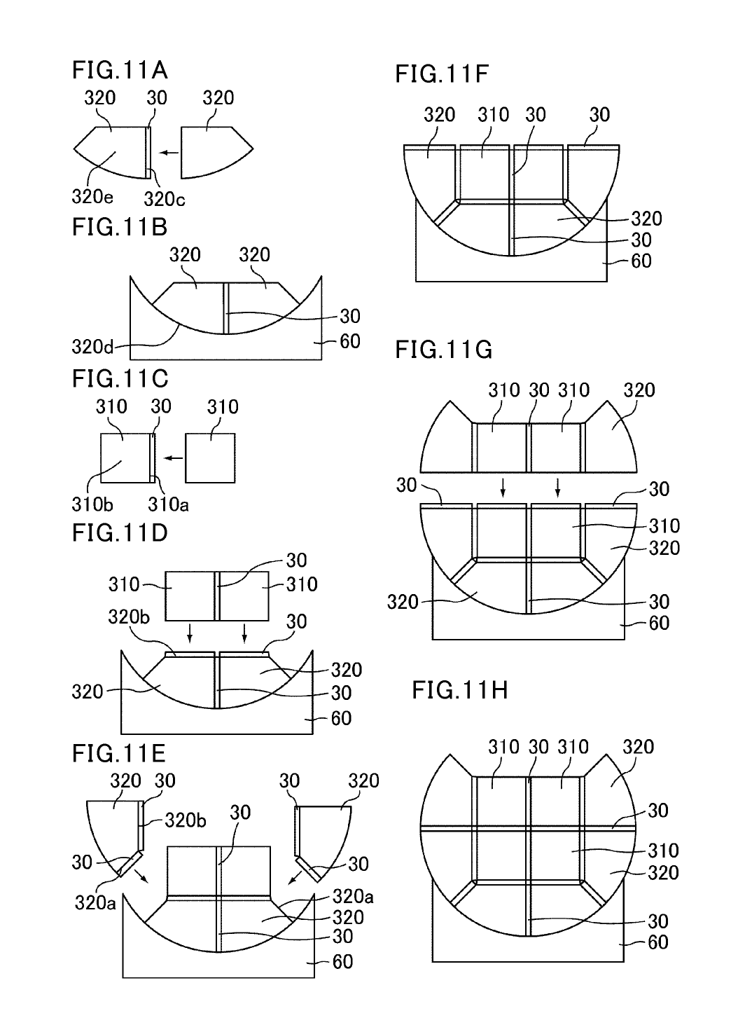

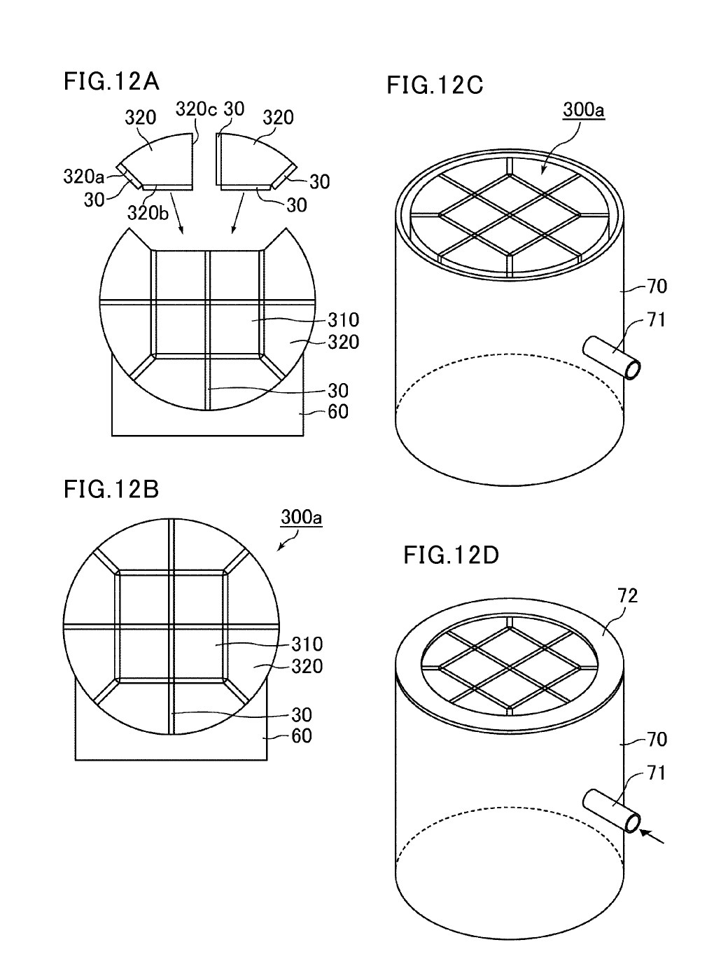

FIGS. 11A to 11H and FIGS. 12A to 12D are schematic explanatory views showing the above steps that are one example of the procedure of manufacturing the honeycomb structure according to the sixth embodiment of the present invention.

First, two edge members 30 each having a substantially quadrangular pillar shape with a side X having substantially the same width as the side 320c1 are formed on the side face 320c of the honeycomb fired body 320, shown in FIG. 10 and disposed on the peripheral portion of the honeycomb structure 300, so that one edge member is brought close to the side 320c1 of one end face 320e of the honeycomb fired body 320 and the other edge member to that of the other end face 320e, with the edge member-applying apparatus 50 used in the first embodiment of the present invention (disposing of edge members). In this case, the edge member preferably has excellent adhesiveness; for example, it is preferably the edge member mentioned in the second or fourth embodiment of the present invention. In the case of the edge members mentioned in the first and third embodiments of the present invention, application of the adhesive paste onto these edge members may enable use of these edge members for bonding (jointing) the honeycomb fired bodies. Even in the below-mentioned steps, application of the adhesive paste may enable bonding (jointing) of the honeycomb fired bodies by interposing the edge members.

As shown in FIG. 11A, the honeycomb fired body 320 with the edge members 30 disposed thereon at two portions and the honeycomb fired body 320 with no edge member 30 disposed thereon are bonded (jointed) to each other by interposing the edge members 30 such that the side faces 320c face to each other and the side faces 320c are perfectly covered with each other. As a result, a bonded (jointed) product is manufactured in which the two honeycomb fired bodies 320 are bonded (jointed) to each other by interposing the edge members 30 while no adhesive paste is applied thereto as shown in FIG. 11B (manufacturing of a honeycomb jointed body).

Then, the bonded (jointed) two honeycomb fired bodies 320 are fixed on a fixing stage 60 such that the side faces 320d forming a curved face of the honeycomb fired bodies 320 is placed downward.

The two quadrangular pillar-shaped honeycomb fired bodies 310 are bonded (jointed) to each other by interposing the edge members 30 at the side faces 310a as shown in FIG. 11C. Then, four edge members 30 are formed on the upper side faces 320b of the two fixed honeycomb fired bodies 320 as shown in FIG. 11D. The two honeycomb fired bodies 310 bonded (jointed) to each other by interposing the edge members 30 are placed on the two honeycomb fired bodies 320 such that the side faces 310a and the side faces 320b are perfectly covered with each other, and they are bonded (jointed) to each other by interposing the edge members 30.

As shown in FIG. 11E, the edge members 30 are formed on the side faces 320a and 320b of the two honeycomb fired bodies 320 in the same manner. Honeycomb fired bodies 320 are bonded (jointed) to the side faces 320a of the bonded (jointed) honeycomb fired bodies 320 and the side faces 310a of the bonded (jointed) honeycomb fired bodies 310 by interposing the edge members 30. Thereby, a honeycomb jointed body having a half round pillar shape is formed as shown in FIG. 11F. Then, edge members 30 are formed on the upper face of this half round pillar-shaped honeycomb jointed body in the same manner as performed above.

As shown in FIG. 11G, two honeycomb fired bodies 310 are bonded (jointed) to each other by interposing an edge member 30, and a honeycomb fired body 320 is bonded (jointed) to each side of the bonded (jointed) honeycomb fired bodies 310 by interposing an edge member 30. Then, this product is bonded (jointed) to the honeycomb jointed body by interposing the edge members 30 as shown in FIG. 11F (FIG. 11H).

As shown in FIG. 12A, two honeycomb fired bodies 320 each with edge members 30 formed on the side face 320a and side face 320b are bonded (jointed) to the honeycomb jointed body shown in FIG. 11H by interposing the edge members 30. Thereby a round pillar-shaped honeycomb jointed body 300a is completed (FIG. 12B).

As shown in FIG. 12C, this completed honeycomb jointed body 300a is placed in a jointed body-housing container 70 that is apart of an adhesive-charging apparatus. As shown in FIG. 12D, a circular lid 72 is placed thereon so that the adhesive paste does not leak from the space formed between the honeycomb jointed body 300a and the jointed body-housing container 70.

The adhesive paste is charged into the jointed body-housing container 70 through a paste-charging pipe 71. Thereby, the adhesive paste is filled into the gaps between the bonded (jointed) honeycomb fired bodies 310 and 320 where no edge member 30 formed, and the adhesive paste is also filled between the periphery of the honeycomb jointed body 300a and the jointed body-housing container 70. As a result, a honeycomb aggregate is manufactured (filling of adhesive paste).

The manufactured honeycomb aggregate is taken out from the jointed body-housing container 70, and is heated for about one hour at from about 50° C. to about 150° C. so that the adhesive paste layers are solidified to be simultaneously adhesive layers and a coating layer. Thereby, a honeycomb structure is manufactured.

In the present embodiment, the honeycomb jointed body is manufactured by the method shown in FIGS. 11A to 11H and FIGS. 12A to 12B. The method of the embodiment of the present invention is not limited to the aforementioned method. For example, the honeycomb jointed body may be manufactured by preliminarily bonding (jointing) multiple honeycomb fired bodies to each other by interposing edge members, and further bonding (jointing) the bonded (jointed) honeycomb fired bodies by interposing edge members.

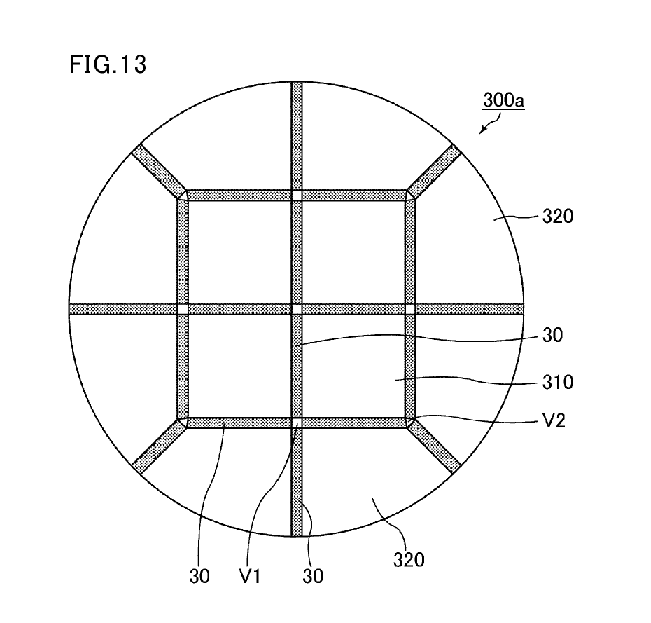

FIG. 13 is an enlarged side view showing the honeycomb jointed body 300a shown in FIG. 12B. This honeycomb jointed body 300a is equipped with the edge members 30 each having substantially the same width as one of the side faces of the honeycomb fired bodies 310 and 320 in the vicinity of the end faces. The portions where no edge member 30 formed are only substantially the cross-shaped center portion V1 and substantially the Y-shaped central portion V2 where the corner portions of the honeycomb fired bodies 310 and 320 are gathered. Such portions have extremely small areas; thus, an adhesive paste having a predetermined viscosity is less likely to leak out therefrom, and the aforementioned filling of the adhesive paste is performed without sealing the end face portions of the honeycomb fired bodies.

As is described in the first embodiment of the present invention, the adhesive paste is perfectly prevented from leaking out toward the end faces by forming the continuous edge member layer when the edge members are formed on the side faces of the honeycomb fired bodies in the examples in which multiple honeycomb fired bodies are bonded (jointed) to each other (see FIGS. 5B and 5C).

The honeycomb structure and the method for manufacturing a honeycomb structure according to the sixth embodiment of the present invention show the same effects as the first embodiment of the present invention.

### Seventh Embodiment

The honeycomb structure according to the seventh embodiment of the present invention is substantially the same as the honeycomb structure according to the sixth embodiment of the present invention. In the method for manufacturing the honeycomb structure, the adhesive paste is charged into the jointed body-housing container 70 through the paste-filling pipe 71 and thereby filled into the gaps between the bonded (jointed) honeycomb fired bodies 310 and 320 where no edge member 30 formed (filling of adhesive paste) in substantially the same manner as in the sixth embodiment of the present invention except that the size of the jointed body-housing container 70 shown in FIG. 12C is changed to substantially the same as the outer size of the honeycomb aggregate.

Then, the manufactured honeycomb aggregate is taken out from the jointed body-housing container 70, and heated for about one hour at from about 50° C. to about 150° C. so that the adhesive paste layers are solidified to be adhesive layers. In the case that a coating layer is not required to be formed on the periphery of the honeycomb structure, the production of the honeycomb structure is finished. In the case that a coating layer is to be formed on the periphery of the honeycomb structure, a seal material paste is applied to the periphery and the seal material paste is dried and solidified to be a coating layer because no coating layer is formed on the periphery of the honeycomb aggregate with the adhesive layers formed therein. Thereby, the production of the honeycomb structure is finished.

The honeycomb structure and the method for manufacturing a honeycomb structure according to the seventh embodiment of the present invention show the same effects as the sixth embodiment of the present invention.

### Other Embodiments

The method for forming an edge member and the method for forming an adhesive paste layer are not particularly limited to those mentioned in the first to seventh embodiments of the present invention, and may be selected from various methods. In the sixth embodiment of the present invention, the coating layer is formed on the periphery of the honeycomb structure 300; however, the coating layer may not be formed. In this case, a sheet and the like may be placed around the honeycomb jointed body so that the adhesive paste does not leak from the peripheral portion instead of the jointed body-housing container, and the adhesive paste may be filled thereinto.

The shape of the honeycomb structure according to the embodiments of the present invention is not particularly limited to a substantially round pillar shape shown in FIG. 1. It may be any pillar shape such as a substantially cylindroid shape, a substantially racetrack pillar shape, a substantially triangular pillar shape (e.g. a triangular pillar with its apexes of the triangle being rounded), and a substantially polygonal pillar shape.

In the honeycomb structure according to the embodiments of the present invention, the cells of the honeycomb fired bodies that constitute the honeycomb structure may include large-volume cells and small-volume cells. A honeycomb fired body including large-volume cells and small-volume cells is a product having cells each having a relatively large cross-sectional area perpendicular to the longitudinal direction and cells each having a relatively small cross-sectional area.

Here, the cross-sectional shapes of the large-volume cells and the small-volume cells are not particularly limited. The cross-sectional shape perpendicular to the longitudinal direction of each large-volume cell may be a substantially octagonal shape, and the cross-sectional shape perpendicular to the longitudinal direction of each small-volume cell may be a substantially quadrangular shape. The cross-sectional shape perpendicular to the longitudinal direction of the large-volume cell may be a substantially quadrangular shape, and the cross-sectional shape perpendicular to the longitudinal direction of the small-volume cell may also be a substantially quadrangular shape. Each side of the cells in the cross section may be a curved line.

In the honeycomb fired body that constitutes the honeycomb structure according to the embodiments of the present invention, ends of the cells may not be sealed. The honeycomb structure of this kind may be used as a catalyst-supporting carrier.

The main component of the constituent material of the honeycomb fired body constituting the honeycomb structure of the embodiments of the present invention is not particularly limited to silicon carbide. It may be other ceramic materials, including: nitride ceramics such as aluminum nitride, silicon nitride, boron nitride, and titanium nitride; carbide ceramics such as zirconium carbide, titanium carbide, tantalum carbide, and tungsten carbide; composites of metals and nitride ceramics; composites of metals and carbide ceramics; and the like.

In addition, examples of the constituent material include ceramic materials such as silicon-containing ceramics formed by mixing metal silicon to the aforementioned ceramics and ceramics bound by silicon or silicate compounds.

The main component of the constituent material of the honeycomb fired body is particularly preferably silicon carbide or silicon-containing silicon carbide.

This is because the components of these kinds are excellent in properties such as heat resistance, mechanical strength, and thermal conductivity.

The material of the adhesive paste is not particularly limited. It preferably contains inorganic particles A, an organic binder, and at least one of inorganic fibers A, whiskers, a scaly inorganic material, and a layered inorganic substance.

Examples of the inorganic binder contained in the adhesive paste include silica sol, alumina sol, and the like. Each of these may be used alone or two or more of these may be used in combination. The inorganic binder is preferably silica sol.

Examples of the organic binder contained in the adhesive paste include polyvinyl alcohol, methyl cellulose, ethyl cellulose, carboxymethyl cellulose, and the like. Each of these may be used alone or two or more of these may be used in combination. The organic binder is preferably carboxymethyl cellulose.

Examples of the inorganic fibers A contained in the adhesive paste include silica-alumina, mullite, alumina, silica, and the like. Each of these may be used alone or two or more of these may be used in combination. The inorganic fibers A are preferably alumina fibers. The inorganic fibers A may be soluble fibers.

Examples of the inorganic particles A contained in the adhesive paste include carbides and nitrides. Specific examples thereof include inorganic powders of silicon carbide, silicon nitride, and boron nitride. Each of these may be used alone or two or more of these may be used in combination. The inorganic particles A are preferably silicon carbide excellent in thermal conductivity.

Further, the adhesive paste may contain a pore-forming agent, if necessary, such as balloons that are fine hollow spheres containing oxide ceramics, spherical acrylic particles, or graphite. The balloons are not particularly limited, and examples thereof include alumina balloons, glass micro balloons, shirasu balloons, fly ash balloons (FA balloons), mullite balloons, and the like. Preferable among these are alumina balloons.

The honeycomb structure may carry a catalyst. The catalyst supported on the honeycomb structure is preferably a noble metal such as platinum, palladium, or rhodium, for example. More preferable among these is platinum. Examples of other catalysts include alkaline metals such as potassium and sodium, and alkaline earth metals such as barium. Each of these catalysts may be used alone, or two or more of these may be used in combination.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb structure comprising:
honeycomb fired bodies each having cell walls extending along a longitudinal direction of the honeycomb fired bodies to define cells, each of the honeycomb fired bodies having a first end face, a second end face opposite to the first end face in the longitudinal direction, and side faces provided between the first end face and the second end face, each of the side faces having a first side that is one side of one of the first end face and the second end face;
adhesive layers disposed on the side faces bonding the honeycomb fired bodies to each other; and
edge members disposed on the side faces and including an inorganic material, each of the edge members having a substantially quadrangular pillar shape with a second side that has substantially a same width as the first side, each of the edge members being disposed such that the second side is in a vicinity of one of the first end face and the second end face.

2. The honeycomb structure according to claim 1,
wherein the side faces have first edge portions and second edge portions opposite to the first edge portions in the longitudinal direction, and
wherein the edge members are disposed on the side faces on which the adhesive layers are provided and at both the first edge portions and the second edge portions of the side faces such that the second side of each of the edge members touches one of the first end face and the second end face.

3. The honeycomb structure according to claim 1,
wherein each of the edge members includes first inorganic particles and first inorganic fibers.

4. The honeycomb structure according to claim 1,
wherein each of the edge members further includes solids content of an inorganic binder.

5. The honeycomb structure according to claim 1,
wherein each of the edge members has substantially a same composition as the adhesive layers.

6. The honeycomb structure according to claim 3,
wherein each of the edge members further includes second inorganic particles or a layered inorganic material.

7. The honeycomb structure according to claim 1,
wherein a honeycomb fired body among the honeycomb fired bodies has a peripheral wall provided on a peripheral portion of the honeycomb fired body, the honeycomb fired body being provided at a peripheral portion of the honeycomb structure.

8. The honeycomb structure according to claim 1,
wherein the cells have first end portions and second end portions opposite to the first end portions in the longitudinal direction, and
wherein one of the first end portions and the second end portions is sealed in each of the honeycomb fired bodies.

9. The honeycomb structure according to claim 1,
wherein the second side is separated from the first side by about 3 mm or less.

10. The honeycomb structure according to claim 9,
wherein the second side is separated from the first side by about 1 mm or less.

11. The honeycomb structure according to claim 1,
wherein each of the edge members comprises a solidified adhesive paste.

12. The honeycomb structure according to claim 1,
wherein each of the edge members comprises a sheet material including a nonflammable material, and
wherein each of the edge members is attached to each of the honeycomb fired bodies via an adhesive paste applied to a main surface of the sheet material.

13. The honeycomb structure according to claim 1,
wherein each of the edge members comprises substantially a same material as the honeycomb fired bodies, and
wherein each of the edge members is integrally provided with each of the honeycomb fired bodies by providing a wet-mixture layer having a same shape as the edge members in a vicinity of an end face on a side face of a honeycomb molded body, and then firing the honeycomb molded body having the wet-mixture layer.

14. The honeycomb structure according to claim 1,
wherein each of the edge members comprises a solidified matter of a paste having a viscosity higher than a viscosity of an adhesive paste which forms the adhesive layers.

15. The honeycomb structure according to claim 1,
wherein border lines are provided between the edge members and the adhesive layers.

16. The honeycomb structure according to claim 1,
wherein each of the edge members includes third inorganic particles, an inorganic binder, an organic binder, and at least one of second inorganic fibers, whiskers, a scaly inorganic material, and a layered inorganic material.

17. The honeycomb structure according to claim 4,
wherein the inorganic binder comprises silica sol or alumina sol.

18. The honeycomb structure according to claim 16,
wherein the inorganic binder comprises silica sol or alumina sol.

19. The honeycomb structure according to claim 16,
wherein the second inorganic fibers comprise silica-alumina, mullite, alumina, silica, or bio-soluble fibers.

20. The honeycomb structure according to claim 16,
wherein the third inorganic particles comprise silicon carbide, silicon nitride, or boron nitride.

21. The honeycomb structure according to claim 1,
wherein each of the edge members has a third side extending in a width direction of each of the edge members and a fourth side extending in a thickness direction of each of the edge members,
wherein a width along the third side is from about 3 mm to about 15 mm, and
wherein a thickness along the fourth side is from about 5 mm to about 10 mm.

22. The honeycomb structure according to claim 12,
wherein the sheet material comprises an inorganic fibrous paper or an inorganic filler paper.

23. The honeycomb structure according to claim 22,
wherein the inorganic fibrous paper comprises first inorganic fibers as main components, and
wherein the inorganic filler paper comprises at least one of first inorganic particles and fine inorganic fibers as main components.

24. The honeycomb structure according to claim 3,
wherein the first inorganic fibers include at least one of alumina, zirconia, alumina-silica, silica, glass, calcium silicate, magnesium silicate, rock wool, glass wool, mineral fibers, and synthetic fibers.

25. The honeycomb structure according to claim 23,
wherein the first inorganic fibers include at least one of alumina, zirconia, alumina-silica, silica, glass, calcium silicate, magnesium silicate, rock wool, glass wool, mineral fibers, and synthetic fibers.

26. The honeycomb structure according to claim 3,
wherein the first inorganic particles include at least one of silica, titania, alumina, zirconia, spinel, magnesia, aluminum hydroxide, calcium carbonate, talc, calcium silicate, magnesium silicate, perlite, vermiculite, and diatomite.

27. The honeycomb structure according to claim 23,
wherein the first inorganic particles include at least one of silica, titania, alumina, zirconia, spinel, magnesia, aluminum hydroxide, calcium carbonate, talc, calcium silicate, magnesium silicate, perlite, vermiculite, and diatomite.

28. The honeycomb structure according to claim 13,
wherein each of the edge members comprises silicon carbide or silicon-containing silicon carbide as a main component.

29. The honeycomb structure according to claim 1,
wherein each of the edge members is integrally provided with each of the honeycomb fired bodies by preliminarily preparing a predetermined sheet-shaped dried body or a predetermined sheet-shaped fired body from substantially a same material as the honeycomb fired bodies, disposing the sheet-shaped dried body or the sheet-shaped fired body on a side face of a honeycomb molded body, and firing the honeycomb molded body.

30. The honeycomb structure according to claim 6,
wherein the second inorganic particles comprise ceramic balloons.

31. The honeycomb structure according to claim 30,
wherein the ceramic balloons include alumina balloons or silica balloons.

32. The honeycomb structure according to claim 1,
wherein the cells have first end portions and second end portions opposite to the first end portions in the longitudinal direction, and
wherein the first end portions and the second end portions are not sealed in each of the honeycomb fired bodies.

33. The honeycomb structure according to claim 1,
wherein the honeycomb fired bodies each comprise silicon carbide or silicon-containing silicon carbide as a main component.

34. The honeycomb structure according to claim 1,
wherein the honeycomb structure carries a catalyst.

35. A method for manufacturing a honeycomb structure, comprising:
providing honeycomb fired bodies each having cell walls extending along a longitudinal direction of the honeycomb fired bodies to define cells, each of the honeycomb fired bodies having a first end face, a second end face opposite to the first end face in the longitudinal direction, and side faces provided between the first end face and the second end face, each of the side faces having a first side that is one side of one of the first end face and the second end face;
disposing edge members on the side faces, the edge members including an inorganic material, each of the edge members having a substantially quadrangular pillar shape with a second side that has substantially a same width as the first side and that is disposed such that the second side is in a vicinity of one of the first end face and the second end face;
connecting the honeycomb fired bodies with the edge members by interposing adhesive paste layers between the honeycomb fired bodies to manufacture a honeycomb aggregate; and
solidifying the adhesive paste layers to provide adhesive layers.

36. The method according to claim 35,
wherein the connecting step includes
applying an adhesive paste to one of the side faces of a first honeycomb fired body among the honeycomb fired bodies with the edge members disposed on the one of the side faces,
bonding one of the side faces of a second honeycomb fired body among the honeycomb fired bodies to the adhesive paste applied to the one of the side faces of the first honeycomb fired body, and
repeating the applying step and the bonding step to manufacture the honeycomb aggregate.

37. The method according to claim 35,
wherein the connecting step includes
jointing the honeycomb fired bodies with the edge members by interposing the edge members between the honeycomb fired bodies to manufacture a honeycomb jointed body,
housing the honeycomb jointed body in a jointed body-housing container that is a part of an adhesive-filling apparatus, and
filling an adhesive paste into gaps formed between the honeycomb fired bodies of the honeycomb jointed body to provide layers to be the adhesive layers.

38. The method according to claim 35,
wherein the connecting step includes
jointing the honeycomb fired bodies with the edge members by interposing the edge members between the honeycomb fired bodies to manufacture a honeycomb jointed body,
preparing a jointed body-housing container that is a part of an adhesive-filling apparatus and that is designed to have a size such that the honeycomb jointed body and the jointed body-housing container form a gap having a predetermined distance between the honeycomb jointed body and the jointed body-housing container,
housing the honeycomb jointed body in the jointed body-housing container to form the gap having a predetermined distance between the honeycomb jointed body and the jointed body-housing container, and
filling an adhesive paste into gaps between the honeycomb fired bodies of the honeycomb jointed body and into the gap between the honeycomb jointed body and the jointed body-housing container to provide first layers to be the adhesive layers and a second layer to be a coating layer.

39. The method according to claim 35,
wherein the side faces have first edge portions and second edge portions opposite to the first edge portions in the longitudinal direction, and
wherein the edge members are disposed on the side faces on which the adhesive layers are provided and at both the first edge portions and the second edge portions of the side faces such that the second side of each of the edge members touches one of the first end face and the second end face.

40. The method according to claim 35,
wherein each of the edge members is bonded to each of the side faces by interposing the adhesive paste between each of the edge members and each of the side faces.

41. The method according to claim 35,
wherein each of the edge members is produced from a highly viscous paste matter.

42. The method according to claim 35,
wherein each of the edge members includes first inorganic particles and first inorganic fibers.

43. The method according to claim 35,
wherein each of the edge members includes an inorganic binder.

44. The method according to claim 35,
wherein each of the edge members has substantially a same composition as the adhesive layers.

45. The method according to claim 42,
wherein each of the edge members further includes second inorganic particles or a layered inorganic material.

46. The method according to claim 35,
wherein a honeycomb fired body among the honeycomb fired bodies has a peripheral wall provided on a peripheral portion of the honeycomb fired body, the honeycomb fired body being provided at a peripheral portion of the honeycomb structure.

47. The method according to claim 35, further comprising:
cutting the honeycomb aggregate to form a peripheral portion of the honeycomb structure after the adhesive layers are solidified.

48. The method according to claim 47, further comprising:
providing a coating layer on a periphery of the honeycomb structure after the cutting step.

49. The method according to claim 35,
wherein a paste having a viscosity of from about 60 Pa·s to about 100 Pa·s is used to provide the edge members.

50. The method according to claim 35,
wherein each of the edge members comprises a solidified member or a fired member having a predetermined shape.

51. The method according to claim 35,
wherein the cells have first end portions and second end portions opposite to the first end portions in the longitudinal direction, and
wherein one of the first end portions and the second end portions is sealed in each of the honeycomb fired bodies.

52. The method according to claim 35,
wherein the second side is separated from the first side by about 3 mm or less.

53. The method according to claim 52,
wherein the second side is separated from the first side by about 1 mm or less.

54. The method according to claim 35,
wherein each of the edge members comprises a solidified adhesive paste.

55. The method according to claim 35,
wherein each of the edge members comprises a sheet material including a nonflammable material, and
wherein each of the edge members is attached to each of the honeycomb fired bodies via an adhesive paste applied to a main surface of the sheet material.

56. The method according to claim 35,
wherein each of the edge members comprises substantially a same material as the honeycomb fired bodies, and
wherein each of the edge members is integrally provided with each of the honeycomb fired bodies by providing a wet-mixture layer having a same shape as the edge members in a vicinity of an end face on a side face of a honeycomb molded body, and then firing the honeycomb molded body having the wet-mixture layer.

57. The method according to claim 35,
wherein each of the edge members comprises a solidified matter of a paste having a viscosity higher than a viscosity of an adhesive paste which forms the adhesive layers.

58. The method according to claim 35,
wherein border lines are provided between the edge members and the adhesive layers in the honeycomb structure.

59. The method according to claim 35,
wherein each of the edge members includes third inorganic particles, an inorganic binder, an organic binder, and at least one of second inorganic fibers, whiskers, a scaly inorganic material, and a layered inorganic material.

60. The method according to claim 43,
wherein the inorganic binder comprises silica sol or alumina sol.

61. The method according to claim 59,
wherein the inorganic binder comprises silica sol or alumina sol.

62. The method according to claim 59,
wherein the second inorganic fibers comprise silica-alumina, mullite, alumina, silica, or bio-soluble fibers.

63. The method according to claim 59,
wherein the third inorganic particles comprise silicon carbide, silicon nitride, or boron nitride.

64. The method according to claim 35,
wherein each of the edge members has a third side extending in a width direction of each of the edge members and a fourth side extending in a thickness direction of each of the edge members,
wherein a width along the third side is from about 3 mm to about 15 mm, and
wherein a thickness along the fourth side is from about 5 mm to about 10 mm.

65. The method according to claim 55,
wherein the sheet material comprises an inorganic fibrous paper or an inorganic filler paper.

66. The method according to claim 65,
wherein the inorganic fibrous paper comprises first inorganic fibers as main components, and
wherein the inorganic filler paper comprises at least one of first inorganic particles and fine inorganic fibers as main components.

67. The method according to claim 42,
wherein the first inorganic fibers include at least one of alumina, zirconia, alumina-silica, silica, glass, calcium silicate, magnesium silicate, rock wool, glass wool, mineral fibers, and synthetic fibers.

68. The method according to claim 66,
wherein the first inorganic fibers include at least one of alumina, zirconia, alumina-silica, silica, glass, calcium silicate, magnesium silicate, rock wool, glass wool, mineral fibers, and synthetic fibers.

69. The method according to claim 42,
wherein the first inorganic particles include at least one of silica, titania, alumina, zirconia, spinel, magnesia, aluminum hydroxide, calcium carbonate, talc, calcium silicate, magnesium silicate, perlite, vermiculite, and diatomite.

70. The method according to claim 66,
wherein the first inorganic particles include at least one of silica, titania, alumina, zirconia, spinel, magnesia, aluminum hydroxide, calcium carbonate, talc, calcium silicate, magnesium silicate, perlite, vermiculite, and diatomite.

71. The method according to claim 56,
wherein each of the edge members comprises silicon carbide or silicon-containing silicon carbide as a main component.

72. The method according to claim 35,
wherein each of the edge members is integrally provided with each of the honeycomb fired bodies by preliminarily preparing a predetermined sheet-shaped dried body or a predetermined sheet-shaped fired body from substantially a same material as the honeycomb fired bodies, disposing the sheet-shaped dried body or the sheet-shaped fired body on a side face of a honeycomb molded body, and firing the honeycomb molded body.

73. The method according to claim 45,
wherein the second inorganic particles comprise ceramic balloons.

74. The method according to claim 73,
wherein the ceramic balloons include alumina balloons or silica balloons.

75. The method according to claim 35,
wherein the cells have first end portions and second end portions opposite to the first end portions in the longitudinal direction, and
wherein the first end portions and the second end portions are not sealed in each of the honeycomb fired bodies.

76. The method according to claim 35,
wherein the honeycomb fired bodies each comprise silicon carbide or silicon-containing silicon carbide as a main component.

77. The method according to claim 35,
wherein the honeycomb structure carries a catalyst.

78. The method according to claim 49,
wherein an adhesive paste which is used to provide the adhesive layers has a viscosity of from about 30 Pa·s to about 60 Pa·s.
